(19) United States
(12) Patent Application Publication
(10) Pub. No.: US 2025/0015453 A1
(43) Pub. Date: Jan. 9, 2025

(54) BATTERY AND ELECTRONIC DEVICE INCLUDING THE BATTERY

(71) Applicant: SAMSUNG ELECTRONICS CO., LTD., Suwon-si (KR)

(72) Inventors: Jungho CHU, Suwon-si (KR); Shihyun Kim, Suwon-si (KR); Seonyoung Park, Suwon-si (KR); Kiyoun Jang, Suwon-si (KR)

(73) Assignee: SAMSUNG ELECTRONICS CO., LTD., Suwon-si (KR)

(21) Appl. No.: 18/764,705

(22) Filed: Jul. 5, 2024

Related U.S. Application Data
(63) Continuation of application No. PCT/KR2024/009394, filed on Jul. 3, 2024.

(30) Foreign Application Priority Data
Jul. 5, 2023 (KR) 10-2023-0086938
Sep. 5, 2023 (KR) 10-2023-0117770

(51) Int. Cl. H01M 50/536; H01M 10/04; H01M 50/247; H01M 50/528

(52) U.S. Cl. CPC H01M 50/536; H01M 10/045; H01M 10/0459; H01M 50/247; H01M 50/528

(57) ABSTRACT

A battery may include: a negative electrodes including a negative electrode including a first tab portion, and a negative electrode current collector including a first recess; positive electrodes arranged alternately with the negative electrodes, and including a positive electrode including a second tab portion, and a positive electrode current collector including a second recess; a separator between two adjacent electrodes among the negative electrodes and the positive electrodes; a first lead tab in the first recess; and a second lead tab in the second recess, wherein the first tab portion is welded to the first lead tab so as to form a first welding portion located in the first recess, and the second tab portion is welded to the second lead tab so as to form a second welding portion located in the second recess.

### CROSS-REFERENCE TO RELATED APPLICATIONS

This application is a by-pass continuation application of International Application No. PCT/KR2024/009394 designating the United States, filed on Jul. 3, 2024, in the Korean Intellectual Property Receiving Office, which claims priority to Korean Patent Application No. 10-2023-0086938, filed on Jul. 5, 2023, in the Korean Intellectual Property Office, and Korean Patent Application No. 10-2023-0117770, filed on Sep. 5, 2023, in the Korean Intellectual Property Office, the disclosures of which are incorporated by reference herein in their entireties.

### BACKGROUND

### 1. Technical Field

Various embodiments of the disclosure relate to an electronic device, for example, to an electronic device including a battery.

### 2. Brief Description of Background Art

With the remarkable development of information communication technology and semiconductor technology, the dissemination and usage of various electronic devices are sharply increasing. Recent electronic devices have been developed to enable communication while being carried.

Electronic devices may refer to devices that perform specific functions based on embedded programs, such as home appliances, electronic notes, portable multimedia players (PMPs), mobile communication terminals, tablet personal computers (PCs), video/audio devices, desktop/laptop computers, vehicle navigation systems, and so forth. For example, these electronic devices may output stored information in the form of sound or images. With the increasing integration of electronic devices and the common use of ultra-high-speed and large-volume wireless communication, various functions have recently come to be provided in a single electronic device, such as a mobile communication terminal. For example, various functions such as an entertainment function such as gaming, a multimedia function such as music/video playback, a communication and security function for mobile banking, and a function such as a schedule management or electronic wallet, as well as a communication function have been integrated into a single electronic device. Such electronic devices have become compact such that users can conveniently carry them.

### SUMMARY

According to embodiments of the present disclosure, a battery may be provided and include: a plurality of negative electrodes including a negative electrode including a first tab portion, and a negative electrode current collector including a first recess; a plurality of positive electrodes arranged alternately with the plurality of negative electrodes, and including a positive electrode including a second tab portion, and a positive electrode current collector including a second recess; a separator disposed at positions between two adjacent electrodes among the plurality of negative electrodes and the plurality of positive electrodes; a first lead tab in the first recess of the negative electrode current collector; and a second lead tab in the second recess of the positive electrode current collector, wherein the first tab portion of the negative electrode is welded to the first lead tab so as to form a first welding portion located in the first recess of the negative electrode current collector, and wherein the second tab portion of the positive electrode is welded to the second lead tab so as to form a second welding portion located in the second recess of the positive electrode current collector.

According to embodiments of the present disclosure, a method for manufacturing a battery including an electrode assembly and at least one lead tab at least partially extending outward from the electrode assembly, may be provided. The method may include: performing a first process of manufacturing an electrode plate pile including a plurality of first electrode plates and a plurality of second electrode plates arranged alternately with the plurality of the first electrode plates; performing a second process of placing a first base electrode plate, to which a first lead tab is coupled, on one side of the electrode plate pile and welding the first lead tab to first tab portions of each of the plurality of first electrode plates; and performing a third process of placing a second base electrode plate, to which a second lead tab is coupled, on the one side of the electrode plate pile and welding the second lead tab to second tab portions of each of the plurality of second electrode plates.

According to embodiments of the present disclosure, an electronic device may be provided and include a housing, a processor, and a battery in the housing. The battery may include an electrode assembly, and at least one lead tab at least partially extending outward from the electrode assembly. The electrode assembly may include: a plurality of first electrode plates; a plurality of second electrode plates arranged alternately with the plurality of first electrode plates; and at least one separator between the plurality of first electrode plates and the plurality of second electrode plates, which are arranged alternately with each other. Each of the at least on lead tab may include: a first portion extending in an outward direction of the electrode assembly; and a second portion extending from the first portion and having at least one surface, on which a welding portion is formed, facing the at least one separator.

### BRIEF DESCRIPTION OF DRAWINGS

FIG. 1 is a block diagram illustrating an electronic device in a network environment according to various embodiments of the disclosure;

FIG. 2 is a perspective view illustrating a front surface of an electronic device according to an embodiment of the disclosure;

FIG. 3 is a perspective view illustrating a rear surface of an electronic device according to an embodiment of the disclosure;

FIG. 4 is an exploded perspective view illustrating a front surface of an electronic device according to an embodiment of the disclosure;

FIG. 5 is an exploded perspective view illustrating a rear surface of an electronic device according to an embodiment of the disclosure;

FIG. 6 is a view illustrating a portion of an electronic device according to an embodiment of the disclosure;

FIG. 7 is a cross-sectional view of FIG. 6, taken along a reference line C-C′;

FIG. 8 is a perspective view of a battery cell according to an embodiment of the disclosure;

FIG. 9 is a perspective view of a battery cell according to an embodiment of the disclosure;

FIG. 10 is a cross-sectional view of FIG. 9, taken along a reference line P-P′;

FIG. 11A is a diagram illustrating an operation of a method of manufacturing a battery cell according to an embodiment of the disclosure;

FIG. 11B is a diagram for illustrating an operation of a method of manufacturing a battery cell according to an embodiment of the disclosure;

FIG. 11C is a diagram for illustrating an operation of a method of manufacturing a battery cell according to an embodiment of the disclosure;

FIG. 11D is a diagram illustrating an operation of a method of manufacturing a battery cell according to an embodiment of the disclosure;

FIG. 12A is a diagram for illustrating an operation of a method of manufacturing a battery cell according to an embodiment of the disclosure;

FIG. 12B is a diagram for illustrating an operation of a method of manufacturing a battery cell according to an embodiment of the disclosure;

FIG. 12C is a diagram for illustrating an operation of a method of manufacturing a battery cell according to an embodiment of the disclosure;

FIG. 13A is a diagram illustrating an operation of a method of manufacturing a battery cell according to an embodiment of the disclosure;

FIG. 13B is a diagram for illustrating an operation of a method of manufacturing a battery cell according to an embodiment of the disclosure;

FIG. 13C is a diagram for illustrating an operation of a method of manufacturing a battery cell according to an embodiment of the disclosure;

FIG. 14A is a diagram illustrating an operation of a method of manufacturing a battery cell according to an embodiment of the disclosure;

FIG. 14B is a diagram for illustrating an operation of a method of manufacturing a battery cell according to an embodiment of the disclosure;

FIG. 15A is a diagram illustrating an operation of a method of manufacturing a battery cell according to an embodiment of the disclosure; and

FIG. 15B is a diagram for illustrating an operation of a method of manufacturing a battery cell according to an embodiment of the disclosure.

### DETAILED DESCRIPTION

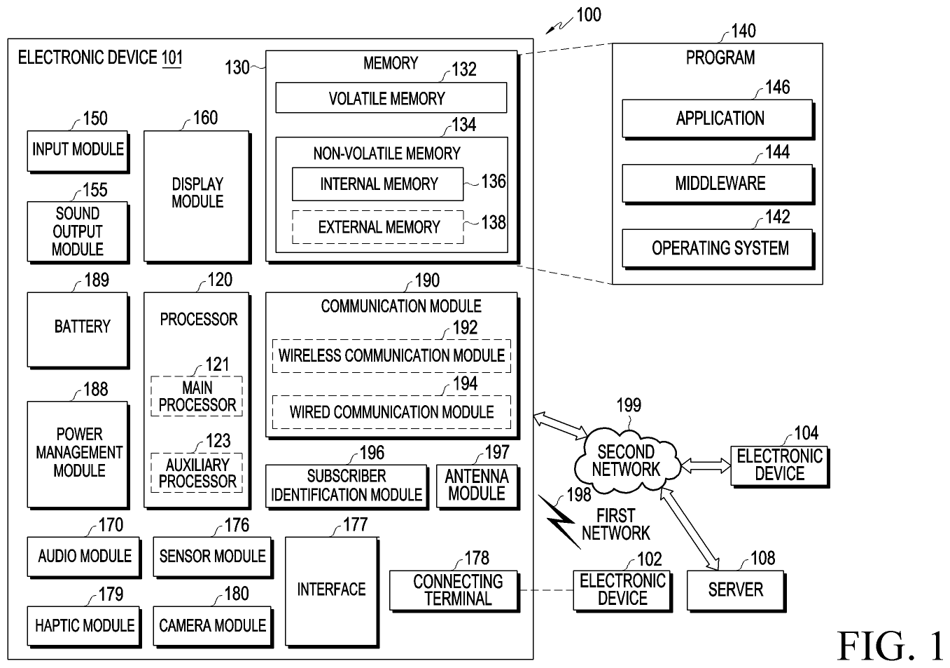

FIG. 1 is a block diagram illustrating an electronic device in a network environment 100 according to an embodiment of the disclosure.

Referring to FIG. 1, the electronic device 101 in the network environment 100 may communicate with an external electronic device 102 via a first network 198 (e.g., a short-range wireless communication network), or an external electronic device 104 or a server 108 via a second network 199 (e.g., a long-range wireless communication network). According to an embodiment, the electronic device 101 may communicate with the external electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. In an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least portion of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as portion of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as portion of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as portion of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a second sensor module configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment, the interface 177 may include, for example, a high-definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least portion of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other portions (e.g., radio frequency integrated circuit (RFIC)) than the radiator may be further formed as portion of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least portion of the function or the service. The one or more external electronic devices receiving the request may perform the at least portion of the function or the service requested, or an additional function or an additional service related to the request, and transfer an outcome of the performing to the electronic device 101. The electronic device 101 may provide the outcome, with or without further processing of the outcome, as at least portion of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

The electronic device according to various embodiments of the disclosure may be one of various types of devices. The electronic devices may include, for example, a portable communication device (e.g., a smartphone), a computer device, a portable multimedia device, a portable medical device, a camera, a wearable device, or a home appliance. The electronic devices according to an embodiment are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “portion,” or “circuitry.” A module may be a single integral component, or a minimum unit or portion thereof, adapted to perform one or more functions. For example, according to an embodiment, the module may be implemented in a form of an application-specific integrated circuit (ASIC).

Various embodiments of the disclosure may be implemented as software (e.g., the program 140) including one or more instructions that are stored in a storage medium (e.g., internal memory 136 or external memory 138) that is leadable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium leadable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-leadable storage medium (e.g., compact disc lead only memory (CD-ROM)), or be distributed (e.g., downloaded or uploaded) online via an application store (e.g., Play Store™), or between two user devices (e.g., smartphones) directly. If distributed online, at least portion of the computer program product may be temporarily generated or at least temporarily stored in the machine-leadable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or further, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

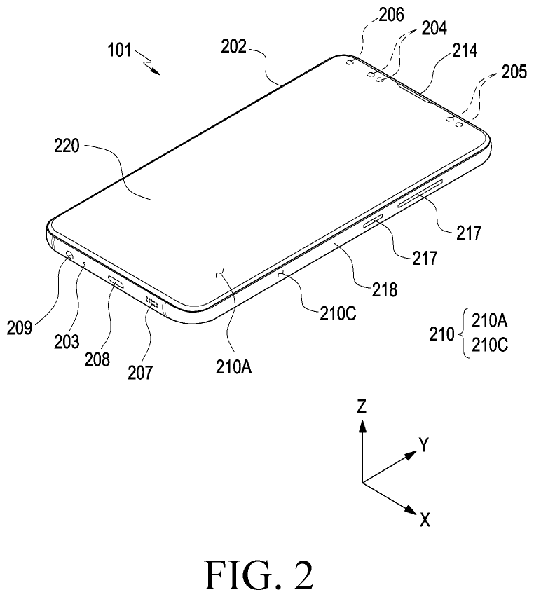

FIG. 2 is a perspective view illustrating a front surface of an electronic device according to an embodiment of the disclosure.

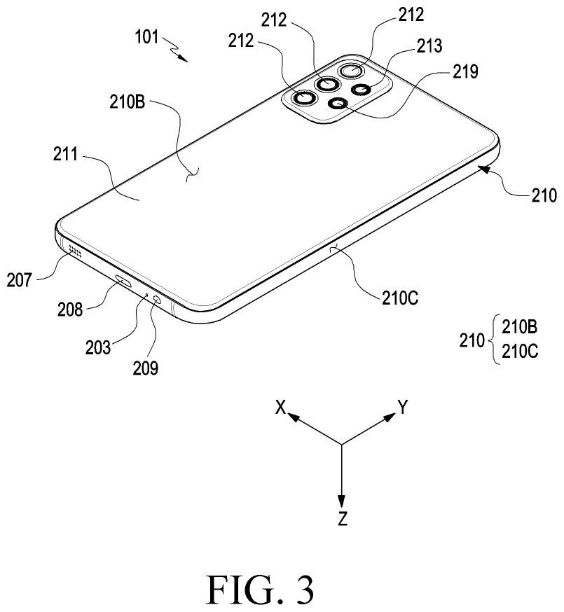

FIG. 3 is a perspective view illustrating a rear surface of an electronic device according to an embodiment of the disclosure.

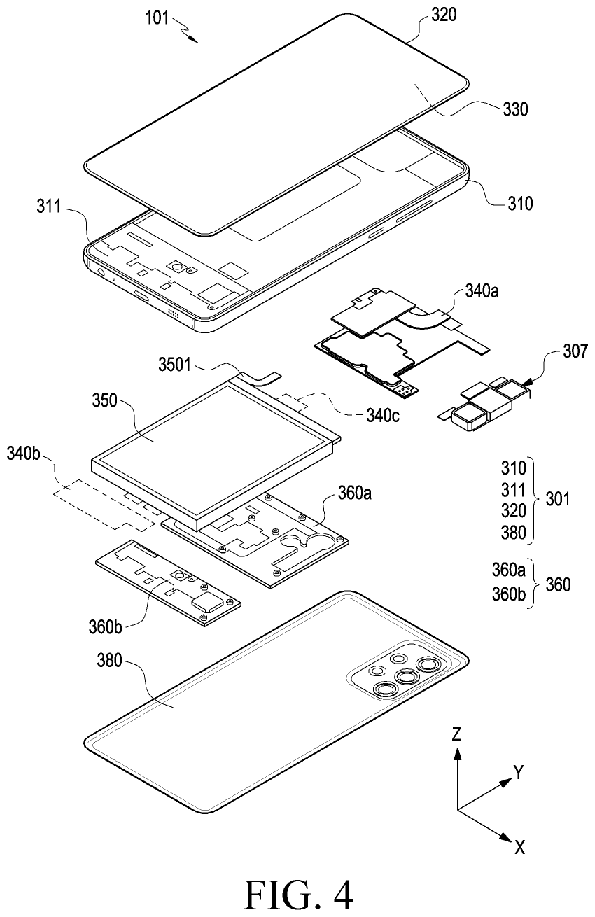

The embodiments of FIGS. 2 to 3 may be combined with the embodiment of FIG. 1 or the embodiments of FIGS. 4 to 11.

Referring to FIGS. 2 and 3, an electronic device 101 (e.g., the electronic device 101 of FIG. 1) according to an embodiment may include a housing 210 which includes a first surface 210A (or front surface), a second surface 210B (or rear surface), and a side surface 210C surrounding a space between the first surface 210A and the second surface 210B. According to an embodiment, the housing 210 may refer to a structure that forms a portion of the first surface 210A of FIG. 2, the second surface 210B, and the side surface 210C of FIG. 3. According to an embodiment, at least portion of the first surface 210A may have a front plate 202 (e.g., a glass plate or polymer plate including various coating layers) that may be substantially transparent. The second surface 210B may be formed by a rear plate 211 which may be substantially opaque. The rear plate 211 may be formed of, for example, coated or colored glass, ceramic, polymer, metal (e.g., aluminum, stainless steel (STS), or magnesium), or a combination of at least two of these materials. The side surface 210C may be formed by a side structure 218 (or a “side bezel structure”) that couples to the front plate 202 and the rear plate 211 and includes a metal and/or polymer. According to an embodiment, the rear plate 211 and the side structure 218 may be integrally formed and include the same material (e.g., a metal, such as aluminum).

According to embodiments, the front plate 202 may include an area(s) bent and extending seamlessly from at least a portion of an edge thereof toward the rear plate 211. In an embodiment, the front plate 202 (or the rear plate 211) may include only one of the areas bent and extending seamlessly toward the rear plate 211 (or the front plate 202) at one edge of the first surface 210A. According to an embodiment, the front plate 202 or the rear plate 211 may be substantially flat in shape, and in this case, may not include a bent extended area. When a bent extended area is included, the electronic device 101 may have a smaller thickness in a portion including the bent extended area than in another portion.

According to an embodiment, the electronic device 101 may include at least one of a display 220, audio modules (e.g., a microphone hole 203, an external speaker hole 207, and a receiver hole 214), sensor modules (e.g., a first sensor module 204, a second sensor module, and a third sensor module 219), camera modules (e.g., a first camera device 205, a second camera device 212, and a flash 213), a key input device 217, a light emitting element 206, and connector holes (e.g., a first connector hole 208 and a second connector hole 209). In an embodiment, the electronic device 101 may omit at least one (e.g., the key input device 217 or the light emitting element 206) of the components or additionally include other components.

The display 220 may be visually exposed, for example, through a substantial portion of the front plate 202. In an embodiment, at least a portion of the display 220 may be exposed through the front plate 202 forming the first surface 210A or a portion of the side surface 210C. In an embodiment, corners of the display 220 may be formed substantially in the same shapes as shapes of adjacent peripheral portions of the front plate 202. In an embodiment, a gap between the periphery of the display 220 and the periphery of the front plate 202 may be substantially equal to increase the visually exposed area of the display 220.

In an embodiment, a recess or an opening may be formed in a portion of a view area of the display 220, and at least one from among the audio module, the sensor module, the camera module, and the light emitting element 206, which is aligned with the recess or the opening, may be included. In an embodiment, at least one from among the audio module, the sensor module, the camera module, a fingerprint sensor, and the light emitting element 206 may be included on the rear surface of the view area of the display 220. In an embodiment, the display 220 may be incorporated with or disposed adjacent to a touch sensing circuit, a pressure sensor that measures the intensity (e.g., pressure) of a touch, and/or a digitizer that detects a magnetic field-based stylus pen.

The audio modules may include a microphone hole 203 and speaker holes. A microphone for obtaining an external sound may be disposed in the microphone hole 203, and in an embodiment, a plurality of microphones may be disposed to detect the direction of a sound. The speaker holes may include an external speaker hole 207 and a receiver hole 214 for calls. In an embodiment, the speaker holes (e.g., the external speaker hole 207 and the receiver hole 214) and the microphone hole 203 may be implemented as a single hole, or a speaker (e.g., a piezo speaker) may be included without the speaker holes (e.g., the external speaker hole 207 and the receiver hole 214).

The sensor modules may generate an electrical signal or data value corresponding to an internal operating state of the electronic device 101 or an external environmental state. The sensor modules may include, for example, a first sensor module 204 (e.g., a proximity sensor) and/or a second sensor module (e.g., a fingerprint sensor), disposed on the first surface 210A, and/or a third sensor module 219 and/or a fourth sensor module (e.g., a fingerprint sensor), disposed on the second surface 210B of the housing 210. The fingerprint sensor may be disposed on the second surface 210B or the side surface 210C as well as on the first surface 210A (e.g., the display 220) of the housing 210. The electronic device 101 may further include at least one of from among, for example, a gesture sensor, a gyro sensor, a barometric pressure sensor, a magnetic sensor, an acceleration sensor, a grip sensor, a color sensor, an infrared (IR) sensor, a biometric sensor, a temperature sensor, a humidity sensor, and an illuminance sensor.

The camera modules may include a first camera device 205 disposed on the first surface 210A of the electronic device 101, and a second camera device 212 and/or a flash 213 disposed on the second surface 210B of the electronic device 101. Each of the camera modules may include one or more lenses, an image sensor, and/or an image signal processor. The flash 213 may include, for example, a light emitting diode (LED) or a xenon lamp. In an embodiment, two or more lenses (an infra-red (IR) camera, a wide-angle lens, and a telephoto lens) and image sensors may be arranged on one surface of the electronic device 101. In an embodiment, the flash 213 may radiate IR light, and the IR light radiated from the flash 213 and reflected from a subject may be received through a third sensor module 219. The electronic device 101 or the processor of the electronic device 101 may detect depth information about the subject based on a time when the IR light is received at the third sensor module.

The key input device 217 may be arranged on the side surface 210C of the housing 210. In an embodiment, the electronic device 101 may not include some or any of the above key input device 217, and any of the key input device 217 which are not included may be implemented in other forms such as soft keys on the display 220. In an embodiment, the key input device may include a sensor module disposed on the second surface 210B of the housing 210.

The light emitting element 206 may be disposed, for example, on the first surface 210A of the housing 210. The light emitting element 206 may provide, for example, state information about the electronic device 101 in the form of light. In an embodiment, the light emitting element 206 may provide, for example, a light source interworking with an operation of the camera module. The light emitting element 206 may include, for example, an LED, an IR LED, and a xenon lamp.

The connector holes may include a first connector hole 208 that may accommodate a connector (e.g., a universal serial bus (USB) connector) for transmitting and receiving power and/or data to and from an external electronic device and a second connector hole 209 (e.g., an earphone jack) that may accommodate a connector for transmitting and receiving an audio signal to and from an external electronic device.

FIG. 4 is an exploded perspective view illustrating the front surface of an electronic device according to an embodiment of the disclosure.

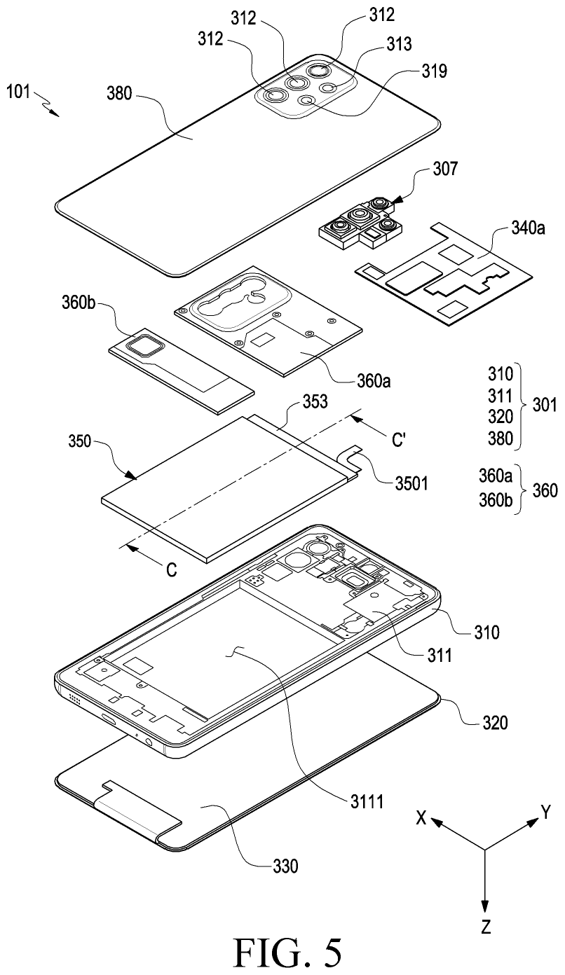

FIG. 5 is an exploded perspective view illustrating the rear surface of an electronic device according to an embodiment of the disclosure.

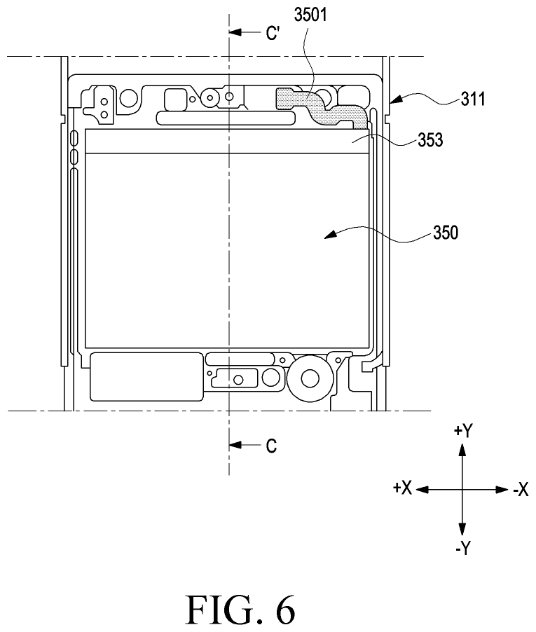

The embodiments of FIGS. 4 to 5 may be combined with the embodiments of FIGS. 1 to 3 or the embodiments of FIGS. 6 to 15B.

Referring to FIGS. 4 and 5, the electronic device 101 (e.g., the electronic device 101 of FIG. 1 or 2) may include a side structure 310, a first support member 311 (e.g., a bracket), a front plate 320 (e.g., the front plate 202 of FIG. 1), a display 330 (e.g., the display 220 of FIG. 1), at least one printed circuit board (PCB) (or board assembly) (e.g., a first printed circuit board 340a and a second printed circuit board 340b), a battery 350, a second support member 360 (e.g., a rear case), an antenna, a camera assembly 307, and a rear plate 380 (e.g., the rear plate 211 of FIG. 2). When including a plurality of PCBs (e.g., the first printed circuit board 340a and the second circuit board 340b), the electronic device 101 may include at least one flexible printed circuit board (FPCB) 340c to electrically connect different PCBs to each other. For example, the PCBs may include a first printed circuit board 340a disposed above the battery 350 (e.g., in the +Y-axis direction) and a second printed circuit board 340b disposed below the battery 350 (e.g., in the −Y-axis direction), and the FPCB 340c may electrically connect the first printed circuit board 340a and the second printed circuit board 340b to each other.

According to an embodiment, the electronic device 101 may omit at least one of the components (e.g., the first support member 311 or the second support member 360) or may additionally include other components. At least one of the components of the electronic device 101 may be the same as or similar to at least one of the components of the electronic device 101 of FIG. 1 or FIG. 2, and a redundant description thereof may be omitted below.

At least a portion of the first support member 311 may be provided in the shape of a flat plate. In an embodiment, the first support member 311 may be disposed inside the electronic device 101 and connected to the side structure 310 or may be integrally formed with the side structure 310. For example, the first support member 311 may be formed of, for example, a metal material and/or a non-metal material (e.g., polymer). When the first support member 311 is at least partially formed of a metal material, a portion of the side structure 310 or first support member 311 may function as an antenna. The display 330 may be coupled to one surface of the first support member 311, and the PCBs (e.g., the first printed circuit board 340a and the second printed circuit board 340b) may be coupled to the other surface thereof. A processor (e.g., the processor 120 of FIG. 1), memory (e.g., the memory 130 of FIG. 1), and/or an interface (e.g., the interface 177 of FIG. 1) may be mounted on the PCBs (e.g., the first PCB 340a and the second PCB 340b). The processor may include, for example, one or more from among a central processing unit (CPU), an application processor (AP), a graphics processing unit (GPU), an image signal processor, a sensor hub processor, and a communication processor.

According to an embodiment, a housing 301 of the electronic device 101 may include the first support member 311 and the side structure 310. According to an embodiment, the housing 301 may be understood as a structure for accommodating, protecting, or disposing the PCB (e.g., the first PCB 340a or the second PCB 340b) or the battery 350. In an embodiment, it may be understood that the housing 301 includes a structure visually or tactilely perceivable by a user on the exterior of the electronic device 101, for example, the side structure 310, the front plate 320, and/or the rear plate 380. For example, the housing 301 may include structures (e.g., the side structure 310, the front plate 320, and the rear plate 380) that form the exterior of the electronic device 101. The housing 301 may be the same as the housing 210 described with reference to FIGS. 2 and 3. In an embodiment, the term “front surface or rear surface of the housing 301” may refer to the first surface 210A of FIG. 1 or the second surface 210B of FIG. 2. In an embodiment, the first support member 311 may be disposed between the front plate 320 (e.g., the first surface 210A of FIG. 1) and the rear plate 380 (e.g., the second surface 210B of FIG. 2), and may function as a structure for disposing electrical/electronic components such as the PCBs (e.g., the first PCB 340a and the second PCB 340b) or the camera assembly 307.

The memory may include, for example, volatile memory or non-volatile memory.

The interface may include, for example, a high-definition multimedia interface (HDMI), a universal serial bus (USB) interface, an SD card interface, and/or an audio interface. The interface may, for example, electrically or physically connect the electronic device 101 to an external electronic device and include a USB connector, an SD card/multimedia card (MMC) connector, or an audio connector.

The second support member 360 may include, for example, an upper support member 360a and/or a lower support member 360b. In an embodiment, the upper support member 360a may be disposed to surround the PCB (e.g., the first circuit board 340a) together with a portion of the first support member 311. For example, the upper support member 360a of the second support member 360 may be disposed to face the first support member 311 with the first printed circuit board 340a interposed therebetween. In an embodiment, the lower support member 360b of the second support member 360 may be disposed to face the first support member 311 with the second printed circuit board 340b interposed therebetween. A circuit device (e.g., a processor, a communication module, or memory) implemented in the form of an integrated circuit chip or various electrical/electronic components may be disposed on the PCBs (e.g., the first printed circuit board 340a and the second printed circuit board 340b), and according to an embodiment, the PCBs (e.g., the first printed circuit board 340a and the second printed circuit board 340b), may be provided with an electromagnetic shielding environment from the second support member 360. In an embodiment, the lower support member 360b may be utilized as a structure capable of disposing an electrical/electronic component such as a speaker module or an interface (e.g., a USB connector, an SD card/MMC connector, or an audio connector). In an embodiment, an electrical/electronic component such as a speaker module or an interface (e.g., a USB connector, an SD card/MMC connector, or an audio connector) may be disposed on an additional printed circuit board. For example, the lower support member 360b may be disposed to surround an additional printed circuit board (e.g., the second printed circuit board 340b) together with another portion of the first support member 311. A speaker module or an interface disposed on the additional printed circuit board or the lower support member 360b may be disposed corresponding to the audio module 207 or the connector holes (e.g., the first connector hole 208 and the second connector hole 209 of FIG. 2.

The battery 350 is a device supplying power to at least one component of the electronic device 101, and may include, for example, a non-rechargeable primary battery, a rechargeable secondary battery, or a fuel cell. At least a portion of the battery 350 may be disposed on substantially the same plane as, for example, the printed circuit boards (e.g., the first printed circuit board 340a and the second printed circuit board 340b. The battery 350 may be integrally disposed inside the electronic device 101 or detachably from the electronic device 101.

According to embodiments, the antenna may include a conductor pattern implemented on a surface of the second support member 360 through, for example, laser direct structuring. In an embodiment, the antenna may include a printed circuit pattern formed on a surface of a thin film, and the antenna in the form of a thin film may be disposed between the rear plate 380 and the battery 350. The antenna may include, for example, a near field communication (NFC) antenna, a wireless charging antenna, and/or a magnetic secure transmission (MST) antenna. The antenna may, for example, perform short-range communication with an external device or wirelessly transmit and receive power required for charging to and from an external device. In an embodiment, another antenna structure may be formed by a portion or a combination of the side structure 310 and/or the first support member 311.

According to an embodiment, the camera assembly 307 may include at least one camera module. The camera assembly 307 (or at least one camera module) may receive at least a portion of light incident through an optical hole or a camera window inside the electronic device 101. In an embodiment, the camera assembly 307 may be disposed on the first support member 311 at a position adjacent to the PCBs (e.g., the first printed circuit board 340a and the second printed circuit board 340b). In an embodiment, the camera module(s) of the camera assembly 307 may be generally aligned with any one of the camera windows, and at least partially surrounded by the second support member 360 (e.g., the upper support member 360a).

According to an embodiment, the first support member 311 may be referred to as a “support member.” The first support member 311 may include a seating portion 3111. The seating portion 3111 may include a recess recessed from one surface of the first support member 311. For example, the battery 350 may be disposed in the seating portion 3111. The seating portion 3111 may be a portion of the first support member 311 that provides a space where the battery 350 is disposed. The seating portion 3111 may have a groove shape recessed from one surface of the first support member 311.

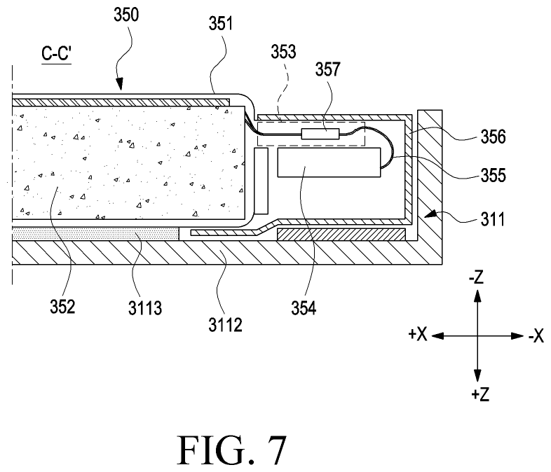

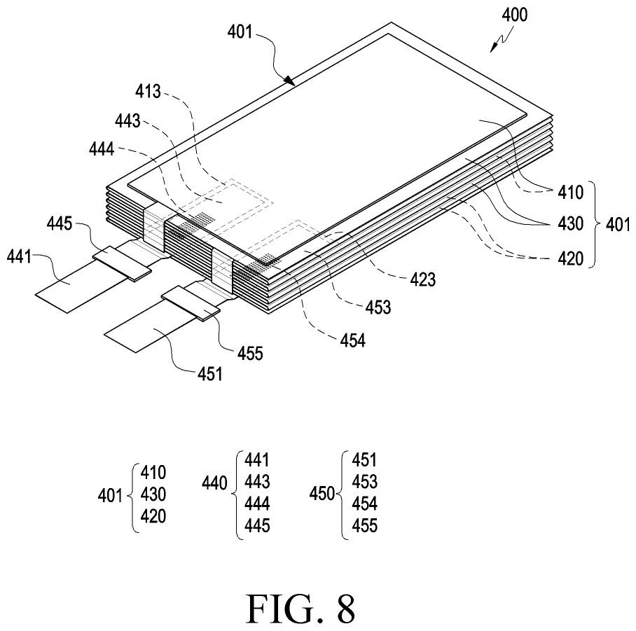

FIG. 6 is an enlarged view of the battery 350 mounted on a first support member 311 according to an embodiment of the disclosure. FIG. 7 is a partial cross-sectional view taken along a reference line C-C′ shown in FIG. 6, in which a portion of the first support member 311 and the battery 350 are cut away. The components described with reference to FIGS. 6 and 7 may be partially or entirely the same as the components described with reference to FIGS. 1 to 5. The components described with reference to FIGS. 6 and 7 may be partially or entirely the same as the components described with reference to FIGS. 8 to 15B.

According to an embodiment, the battery 350 may be disposed on the first support member 311. The electronic device 101 may include an adhesive member 3113. The first support member 311 may include a plate 3112. The plate 3112 may form a portion of the seating portion 3111. For example, the plate 3112 may form one surface of the seating portion 3111 where the battery 350 is disposed. The adhesive member 3113 may be disposed between the battery 350 and the plate 3112. The adhesive member 3113 may attach the battery 350 to the plate 3112.

According to an embodiment, the electronic device 101 may include a connector 3501 (refer to FIG. 4). The connector 3501 may extend outward from the battery 350. The connector 3501 may electrically connect the battery 350 and electrical components (e.g., the first circuit board 340a, the second printed circuit board 340b, and the FPCB 340c of FIG. 4). The connector 3501 may include a flexible PCB (FPCB) and connector components for electrical connection between the battery 350 and the PCB 340. The battery 350 may supply power to electric components (e.g., the first printed circuit board 340a, the second printed circuit board 340b, and the FPCB 340c of FIG. 4).

According to an embodiment, the battery 350 may be a pouch-type battery. The battery 350 may include a battery housing 351 (refer to FIG. 7). The battery housing 351 may form an internal space to accommodate a battery cell 352. The battery 350 may include the battery cell 352. The battery cell 352 may be disposed inside the battery housing 351. The the battery cell 352 may be the same or similar to the battery cell (e.g., the battery cell 400) described with reference to FIGS. 8 to 15B.

According to an embodiment, the battery 350 may include a terrace portion 353. The terrace portion 353 may protrude outward from the battery cell 352. A portion of lead tabs (e.g., a first lead tab 440 and a second lead tab 450 of FIG. 8) may be disposed inside the terrace portion 353. The battery 350 may include a battery circuit 354, a lead tab extension portion 355, a finishing member 356, and a sealing member 357. The lead tab extension portion 355 may electrically connect the battery circuit 354 with the lead tabs (e.g., the first lead tab 440 and the second lead tab 450 of FIG. 8). The finishing member 356 may surround the sealing member 357, the battery circuit 354, and the lead tab extension portion 355. A portion of the lead tabs (e.g., the first lead tab 440 and the second lead tab 450 of FIG. 8) may be surrounded by the sealing member 357 and may connect the battery cell 352 to the battery circuit 354. The battery circuit 354 may include a protection circuit module (PCM). The protection circuit module may protect the battery 350 from overcurrent and over-discharge. The battery circuit 354 may be referred to as a printed circuit board. The printed circuit board (e.g., the FPCB 340c of FIG. 4) may include the battery circuit 354 that includes the protection circuit module.

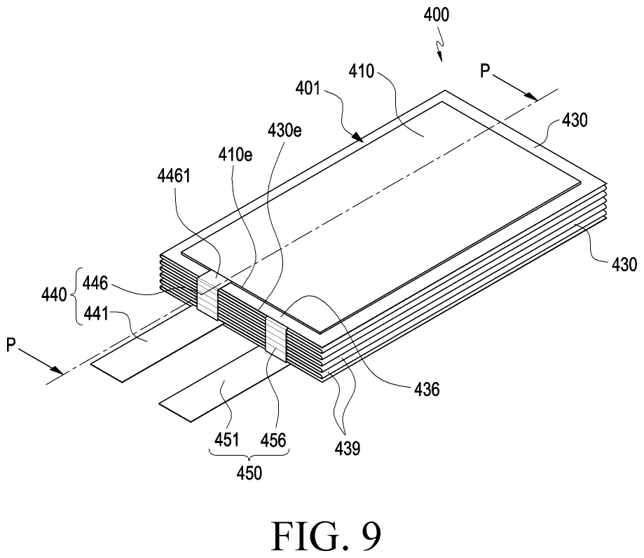

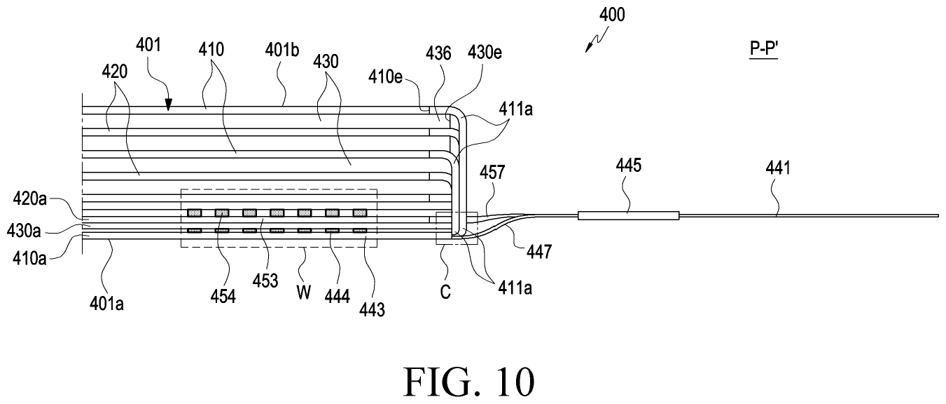

FIG. 8 is a perspective view of a battery cell 400 according to an embodiment of the disclosure. FIG. 9 is a perspective view of a battery cell 400 according to an embodiment of the disclosure. The components described with reference to FIGS. 8 and 9 may be partially or entirely the same as those described with reference to FIGS. 1 to 7. The components described with reference to FIGS. 8 and 9 may be partially or entirely the same as those described with reference to FIGS. 10 to 15B. For example, the description of the battery cell 400 may be identically applied to the description of the battery cell 352 described with reference to FIGS. 1 to 7.

According to an embodiment, a battery (e.g., the battery 350 of FIGS. 1 to 7) may include a battery cell 400. The battery cell 400 may be disposed inside a battery housing (e.g., the battery housing 351 of FIG. 7).

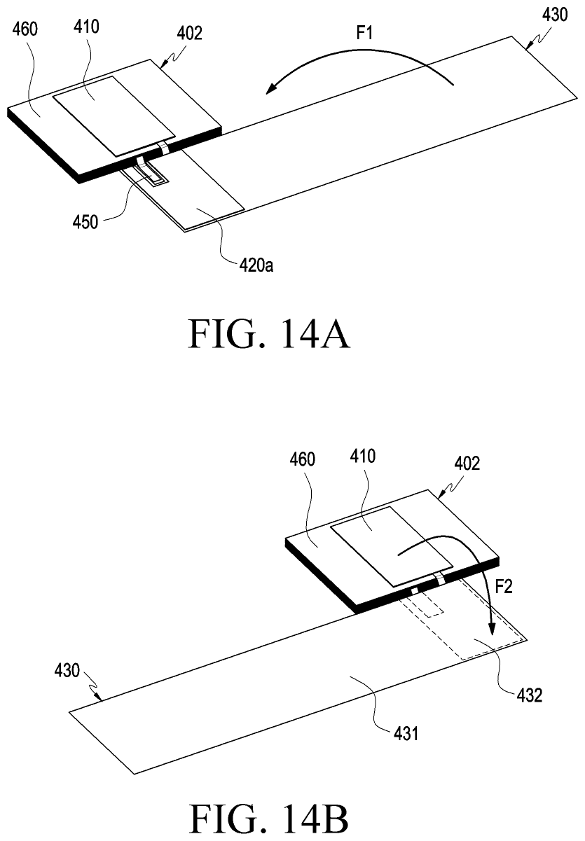

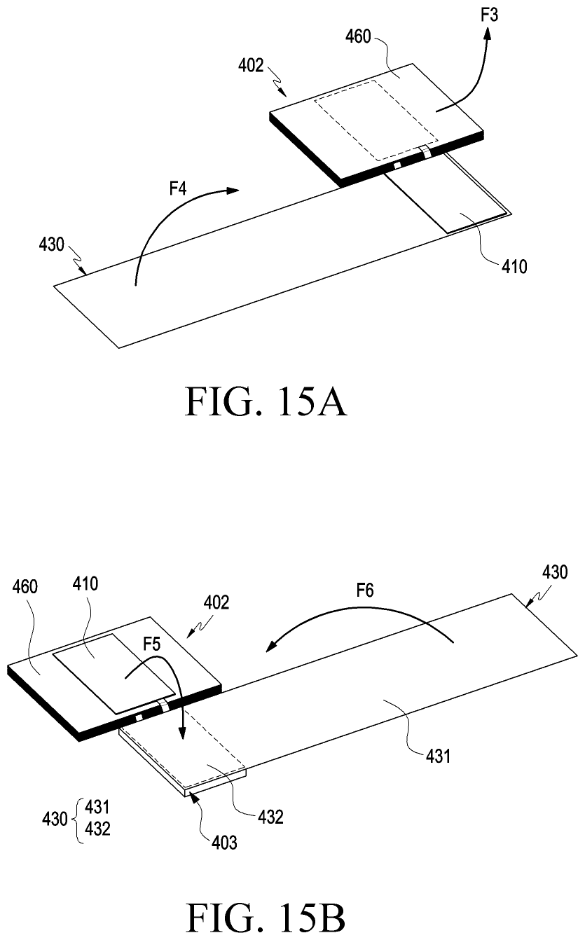

According to an embodiment, the battery cell 400 may include an electrode assembly 401. The electrode assembly 401 may be a structure in which a plurality of electrode plates (e.g., a first electrode plate 410 and a second electrode plate 420) and a plurality of separator layers (e.g., a separator 430) are stacked. The electrode assembly 401 may include the first electrode plate 410. The first electrode plate 410 may be a negative electrode plate. A plurality of the first electrode plate 410 may be disposed. The plurality of the first electrode plate 410 may be spaced apart from each other. The electrode assembly 401 may include the second electrode plate 420. The second electrode plate 420 may be a positive electrode plate. A plurality of the second electrode plate 420 may be disposed. The plurality of second electrode plate 420 may be spaced apart from each other. The electrode assembly 401 may include a separator 430. The separator 430 may include a plurality of layers. A plurality of the layers of the separator 430 may be spaced apart from each other. Referring to FIGS. 14A, 14B, 15A, and 15B, the separator 430 may be configured in the form of a single sheet. Referring to FIGS. 14A, 14B, 15A, and 15B, the separator 430 may be understood as an assembly of a plurality of separator layers disposed inside the battery cell 400. For example, the separator 430 may include a plurality of separator layers. Each of the plurality of separator layers may be disposed between the first electrode plate 410 and the second electrode plate 420. The plurality of the first electrode plate 410 and the plurality of the second electrode plate 420 may be alternately arranged with each other. For example, each of the plurality of the second electrode plate 420 may be disposed between the plurality of the first electrode plate 410. For example, each of the plurality of the first electrode plate 410 may be disposed between the plurality of the second electrode plate 420. The separator 430 may be disposed between the first electrode plate 410 and the second electrode plate 420. Each of the plurality of separator layers of the separator 430 may be disposed between the plurality of the first electrode plate 410 and the plurality of the second electrode plate 420, which are arranged alternately with each other. The electrode assembly 401 may be referred to as an “electrode plate assembly.” The electrode assembly 401 may be referred to as a “stack.” The first electrode plate 410 may be referred to as a “cathode body.” The second electrode plate 420 may be referred to as an “anode body.” The first electrode plate 410 may be referred to as a “negative electrode.” The second electrode plate 420 may be referred to as a “positive electrode.”

According to an embodiment, the battery cell 400 may include lead tabs (e.g., the first lead tab 440 and the second lead tab 450). A plurality of lead tabs (e.g., the first lead tab 440 and the second lead tab 450) may be disposed. For example, two lead tabs (e.g., the first lead tab 440 and the second lead tab 450) may be disposed. The lead tabs may include a first lead tab 440 and a second lead tab 450. The first lead tab 440 may be connected to the first electrode plate 410. The second lead tab 450 may be connected to the second electrode plate 420. The first lead tab 440 may be referred to as a “cathode lead tab.” The second lead tab 450 may be referred to as an “anode lead tab.” The lead tabs (e.g., the first lead tab 440 and the second lead tab 450) may protrude outward from the electrode assembly 401. At least a portion of the lead tabs (e.g., the first lead tab 440 and the second lead tab 450) may be disposed inside the electrode assembly 401. The lead tabs (e.g., the first lead tab 440 and the second lead tab 450) may electrically connect the electrode plates (e.g., the first electrode plate 410 and the second electrode plate 420) with electrical components (e.g., the first printed circuit board 340a, the second printed circuit board 340b, the FPCB 340c of FIG. 4, and the battery circuit 354 of FIG. 7).

According to an embodiment, the first lead tab 440 may be connected to the plurality of the first electrode plate 410. A portion of the first lead tab 440 may be located outside the electrode assembly 401, and the remaining portions of the first lead tab 440 may be located inside the electrode assembly 401.

According to an embodiment, the first lead tab 440 may include a (1-1)th portion 441. The (1-1)th portion 441 may be a portion of the first lead tab 440 located outside the electrode assembly 401. The first lead tab 440 may include a (1-2)th portion 443. The (1-2)th portion 443 may be a portion of the first lead tab 440 located inside the electrode assembly 401.

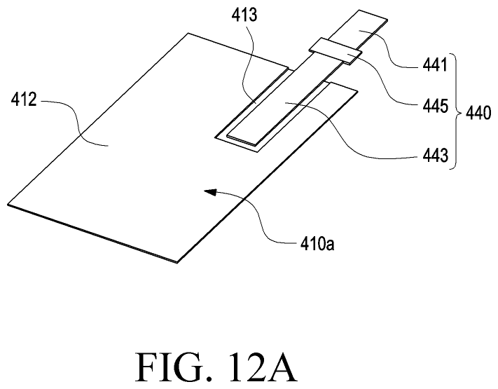

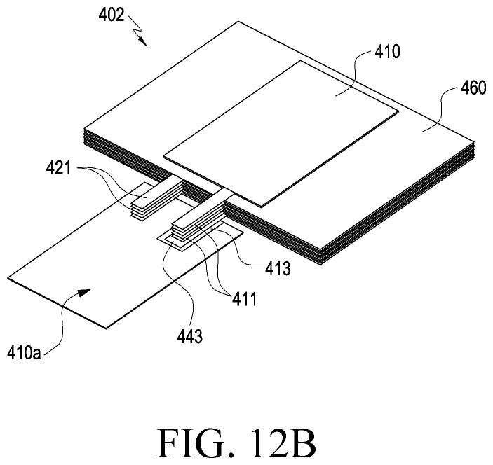

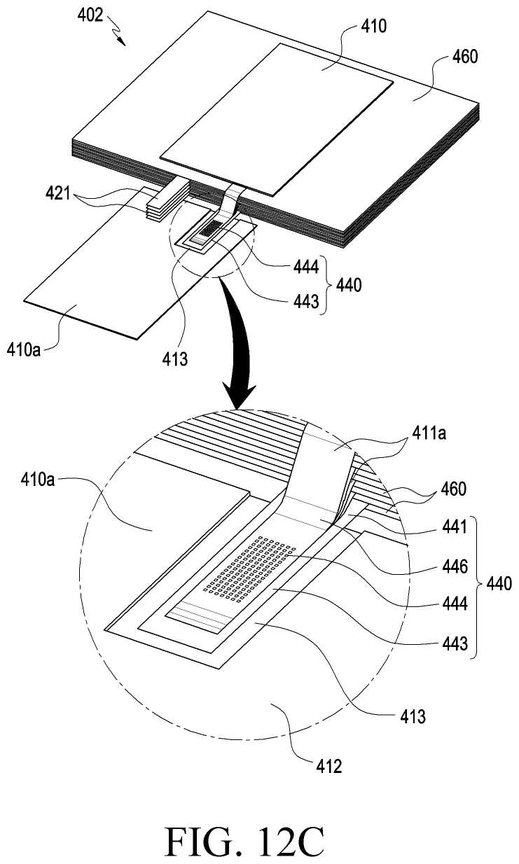

According to an embodiment, the first electrode plate 410 may include a first recess 413. The first recess 413 may be formed by being recessed in a first body (e.g., the first body 412 of FIG. 12A). The first recess 413 may be formed on a first base electrode plate (e.g., the first base electrode plate 410a of FIG. 12A) which is one of the plurality of first electrode plates 410. The (1-2)th portion 443 of the first lead tab 440 may be coupled to the first recess 413. In an embodiment, the first body 412 of the first electrode plate 410 may include an active material. The first recess 413 may be formed in the first body 412. The first recess 413 may not include the active material.

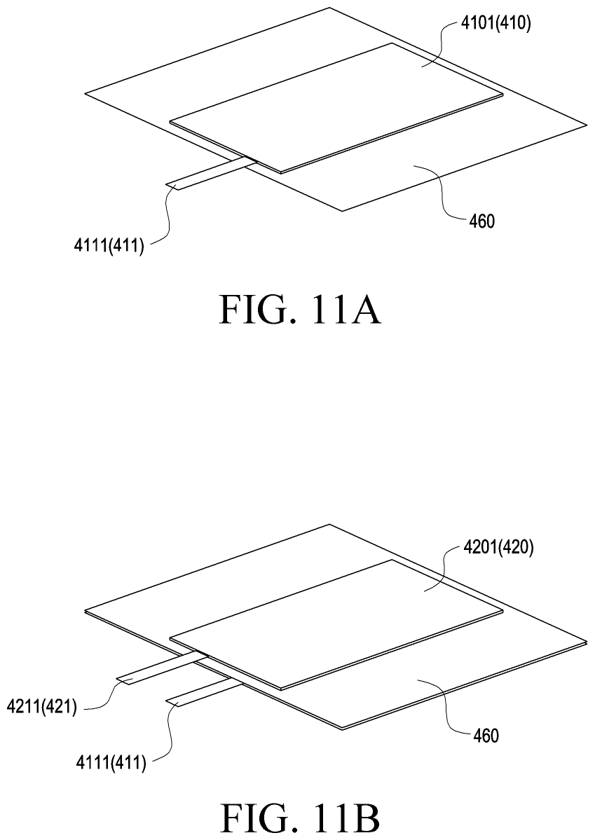

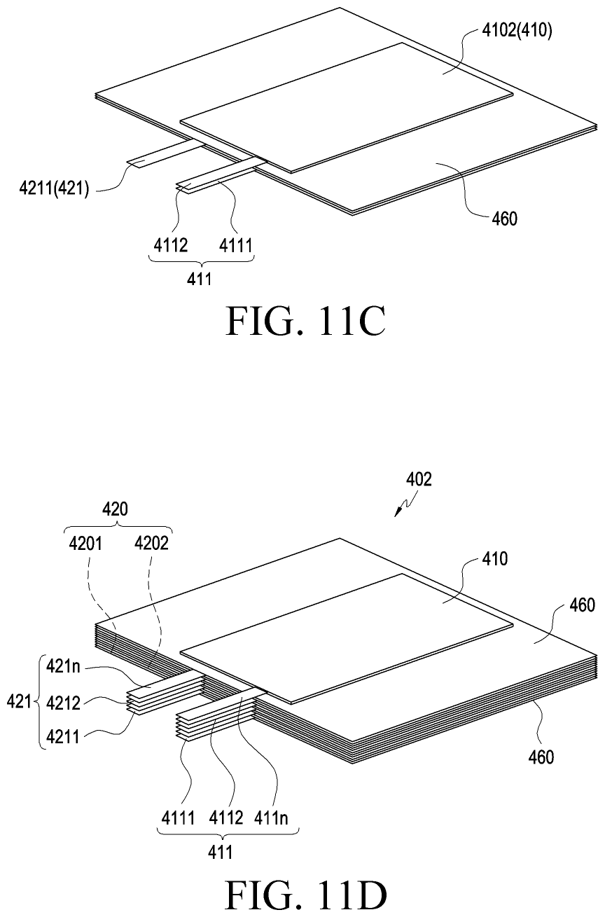

According to an embodiment, the first lead tab 440 may include a first welding portion 444. The first welding portion 444 may be a portion to which a tab portion (e.g., the first tab portion 411 of FIG. 11D) of each of the plurality of first electrode plates 410 is welded. The first welding portion 444 may be a part of the (1-2)th portion 443. The first welding portion 444 may be located inside the electrode assembly 401.

According to an embodiment, the first lead tab 440 may include a first terminal 445. The first terminal 445 may be disposed in one area of the (1-1)th portion 441. The first terminal 445 may be located outside the electrode assembly 401. The first terminal 445 may be electrically connected to an electrical component (e.g., the first printed circuit board 340a, the second printed circuit board 340b, and the FPCB 340c of FIG. 4 or the battery circuit 354 of FIG. 7).

According to an embodiment, the second lead tab 450 may be connected to a plurality of second electrode plates 420. A portion of the second lead tab 450 may be located outside the electrode assembly 401, and the remaining portions of the second lead tab 450 may be located inside the electrode assembly 401.

According to an embodiment, the second lead tab 450 may include a (2-1)th portion 451. The (2-1)th portion 451 may be a portion of the second lead tab 450 located outside the electrode assembly 401. The second lead tab 450 may include a (2-2)th portion 453. The (2-2)th portion 453 may be a portion of the second lead tab 450 located inside the electrode assembly 401.

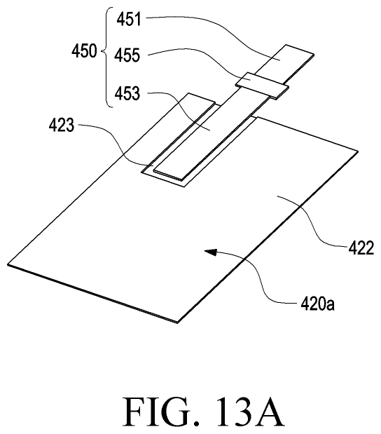

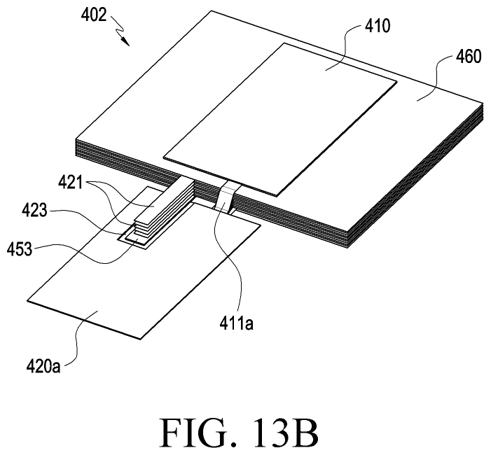

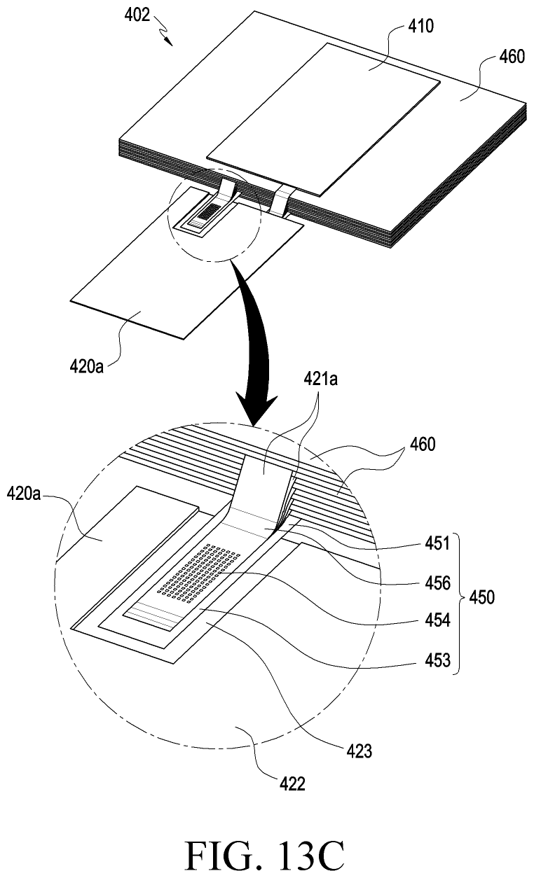

According to an embodiment, the second electrode plate 420 may include a second recess 423. The second recess 423 may be formed by being recessed in a second body (e.g., the second body 422 of FIG. 13A). The second recess 423 may be formed on a second base electrode plate (e.g., the second base electrode plate 420a of FIG. 13A) which is one of the plurality of second electrode plates 420. The (2-2)th portion 453 of the second lead tab 450 may be coupled to the second recess 423. In an embodiment, the second body 422 of the second electrode plate 420 may include an active material. The second recess 423 may be formed in the second body 422. The second recess 423 may not include the active material.

According to an embodiment, the second lead tab 450 may include a second welding portion 454. The second welding portion 454 may be a portion to which a tab portion (e.g., the second tab portion 421 of FIG. 11D) of each of the plurality of second electrode plates 420 is welded. The second welding portion 454 may be a part of the (2-2)th portion 453. The second welding portion 454 may be located inside the electrode assembly 401.

According to an embodiment, the second lead tab 450 may include a second terminal 455. The second terminal 455 may be disposed in one area of the (2-1)th portion 451. The second terminal 455 may be located outside the electrode assembly 401. The second terminal 455 may be electrically connected to an electrical component (e.g., the first printed circuit board 340a, the second printed circuit board 340b, and FPCB 340c of FIG. 4 or the battery circuit 354 of FIG. 7).

According to an embodiment, the lead tabs may include first portions. The first portions may be portions of the lead tabs (e.g., the first lead tab 440 and the second lead tab 450) located outside the electrode assembly 401. The first portions may include a (1-1)th portion 441 and a (2-1)th portion 451.

According to an embodiment, the lead tabs (e.g., the first lead tab 440 and the second lead tab 450) may include second portions. The second portions may be portions of the lead tabs (e.g., the first lead tab 440 and the second lead tab 450) located inside the electrode assembly 401. The second portions may include the (2-1)th portion 443 and the (2-2)th portion 453.

According to an embodiment, the lead tabs (e.g., the first lead tab 440 and the second lead tab 450) may include welding portions (e.g., a first welding portion 444 and a second welding portion 454). The welding portions may be portions where tab portions (e.g., the first tab portion 411 and the second tab portion 421 of FIG. 11D) of each of the plurality of electrode plates 410 and 420 are welded. The welding portions (e.g., the first welding portion 444 and the second welding portion 454) may be parts of the second portions (e.g., the (1-2)th portion 443 and the (2-2)th portion 453). The welding portions may be located inside the electrode assembly 401. The welding portions may include the first welding portion 444 and the second welding portion 454.

According to an embodiment, the lead tabs (e.g., the first lead tab 440 and the second lead tab 450) may include terminals (e.g., a first terminal 445 and a second terminal 455). The terminals may be disposed in the first portions (e.g., the (1-1)th portion 441 and the (2-1)th portion 451). The terminals may be located outside the electrode assembly 401. The terminals may be electrically connected to electrical components (e.g., the first printed circuit board 340a, the second printed circuit board 340b, and the FPCB 340c of FIG. 4 or the battery circuit 354 of FIG. 7). The terminals may include the first terminal 445 and the second terminal 455.

According to an embodiment, the lead tabs (e.g., the first lead tab 440 and the second lead tab 450) may include outer tab portions (e.g., a first connection portion 446 and a second connection portion 456). The outer tab portions may be connected to the second portions (e.g., the (1-2)th portion 443 and the (2-2)th portion 453). The outer tab portions may be connected to the second portions (e.g., the (1-2)th portion 443 and the (2-2)th portion 453) on which the welding portions (e.g., the first welding portion 444 and he second welding portion 454) are formed. The outer tab portions may be partial areas of a plurality of tab portions (e.g., the first tab portion 411 and the second tab portion 421 of FIG. 11D). The outer tab portions may be tab portions disposed at the outermost side of the electrode assembly 401 among the plurality of tab portions. For example, the outer tab portions may be a plurality of tab portions that are bent to at least partially surround one side surface of the electrode assembly 401. The outer tab portions may cover other tab portions (e.g., the first tab portion 411 and the second tab portion 421) among the plurality of tab portions. The outer tab portions may include a first outer tab portion (e.g., a first connection portion 446) connected to the first electrode plate 410 and a second outer tab portion (e.g, a second connection portion 456) connected to the second electrode plate 420.

According to an embodiment, the lead tabs (e.g., the first lead tab 440 and the second lead tab 450) may include an electrode plate connection portion 4461. The electrode plate connection portion 4461 may be connected to the electrode plates (e.g., the first electrode plate 410 and the second electrode plate 420). The electrode plate connection portion 4461 may be a part of any one of a plurality of tab portions (e.g., the first tab portions 411 of FIG. 11D). FIG. 9 may, as an example, illustrate one of a plurality of electrode plate connection portions 4461. For example, the plurality of electrode plate connection portions 4461 may be disposed to correspond to each of the plurality of first electrode plates 410 and may be disposed between the plurality of separator layers. For example, the plurality of electrode plate connection portions 4461 may be disposed to correspond to each of the plurality of second electrode plates 420, may be disposed between the plurality of separator layers, and may be parts of the plurality of tab portions (e.g., the second tab portions 421 of FIG. 11D).

According to an embodiment, the first electrode plate 410 may include a first edge 410e. The separator 430 may include a separator edge 430e. The first edge 410e and the separator edge 430e may be spaced apart from each other. The separator 430 may include a separator end region 436. The separator end region 436 may be a part of the separator 430 formed between the first edge 410e and the separator edge 430e. The separator end region 436 may be a region formed to protrude from the edge regions of the first electrode plate 410 and the second electrode plate 420 so that the two electrode plates are not short. The first tab portion (e.g., the first tab portion 411a of FIG. 10) may span the separator end region 436. The first tab portion 411a may be bent in an extending direction at the separator edge 430e. The separator end region 436 and the separator edge 430e may be formed on each of the plurality of separator layers, and may correspond to each of the plurality of first tab portions 411a. The second electrode plate 420 may include a second tab portion (e.g., the second tab portion 421a of FIG. 13C), and each of the second tab portions 421a may span the separator end region 436 in the same manner as the first tab portion 411a, and may be bent in an extending direction at the separator edge 430e.

According to an embodiment, the separator 430 may include a separator bending portion 439. The separator bending portion 439 may connect separator layers located between the first electrode plate 410 and the second electrode plate 420.

FIG. 10 is a cross-sectional view of a battery cell 400, taken along a reference line P-P′ shown in FIG. 9. The components described with reference to FIG. 10 may be partially or entirely the same as the components described with reference to FIGS. 1 to 9. The components described with reference to FIG. 10 may be partially or entirely the same as the components described with reference to FIGS. 11A to 15B.

According to an embodiment, the electrode assembly 401 may be formed by stacking a plurality of first electrode plates 410, a plurality of second electrode plates 420, and a plurality of layers of a separator 430. The electrode assembly 401 may include a first surface 401a and a second surface 401b. The first surface 401a may form one surface of the electrode assembly 401, and the second surface 401b may form the other surface (e.g., an opposite surface) of the electrode assembly 401.

According to an embodiment, the electrode assembly 401 may include a first base electrode plate 410a. The first base electrode plate 410a may be one of a plurality of first electrode plates 410. The first base electrode plate 410a may be one of a plurality of first electrode plates 410 coated with an active material. The first base electrode plate 410a may be defined as the first electrode plate 410 located closest to the first surface 401a among the plurality of first electrode plates 410. The first base electrode plate 410a may form the first surface 401a. The electrode assembly 401 may include a second base electrode plate 420a. The second base electrode plate 420a may be one of a plurality of second electrode plates 420. The second base electrode plate 420a may be one of the plurality of second electrode plates 420 coated with an active material. The second base electrode plate 420a may be defined as the second electrode plate 420 located closest to the first surface 401a among the plurality of second electrode plates 420. The electrode assembly 401 may include a base separator layer 430a. The base separator layer 430a may be one of a plurality of layers of the separator 430. The base separator layer 430a may be defined as the separator layer located closest to the first surface 401a among the plurality of separator layers. The first base electrode plate 410a may be referred to as a “negative electrode current collector.” The second base electrode plate 420a may be referred to as a “positive electrode current collector.”

According to an embodiment, the welding portions (e.g., the first welding portion 444 and the second welding portion 454) may be located inside the electrode assembly 401. The welding portions (e.g., the first welding portion 444 and the second welding portion 454) may be located between a plurality of layers of a separator 430. The welding portions (e.g., the first welding portion 444 and the second welding portion 454) may face at least one of the plurality of separator layers. In the first welding portion 444 of the battery cell 400 according to an embodiment of the disclosure, a first surface may face one of the plurality of separators 430, and a second surface opposite to the first surface may form a surface of the electrode assembly 401. The first surface may face the separator layer adjacent to the first welding portion 444, and the second surface may not face the separator layer. The first welding portion 444 may be formed on the first base electrode plate 410a. The second welding portion 454 may be formed on the second base electrode plate 420a. In the electrode assembly 401 according to an embodiment of the disclosure, the second base electrode plate 420a may form the first surface 401a of the electrode assembly 401. In the electrode assembly 401 according to an embodiment of the disclosure, the second electrode plate 420 may form the first surface 401a or the second surface 401b. In the electrode assembly 401 according to an embodiment of the disclosure, the first electrode plate 410 may form one from among the first surface 401a and the second surface 401b, and the second electrode plate 420 may form the other from among the first surface 401a and the second surface 401b.

According to an embodiment, the (1-2)th portion 443 may be located inside the electrode assembly 401. The (1-2)th portion 443 may be a part of the first base electrode plate 410a. The first welding portion 444 may be formed in the (1-2)th portion 443, and may form a welding region W together with the (1-2)th portion 443. The (2-2)th portion 453 may be located inside the electrode assembly 401. The (2-2)th portion 453 may be a part of the second base electrode plate 420a. The second welding portion 454 may be formed in the (2-2)th portion 453, and may form the welding region W together with the (2-2)th portion 453.

According to an embodiment, the first tab portions 411a of each of the plurality of first electrode plates 410 may extend toward the first base electrode plate 410a. A plurality of first tab portions 411a may overlap with each other. The plurality of first tab portions 411a may be bundled together and extended toward the first base electrode plate 410a, and may be integrally welded at the (1-2)th portion 443. The second tab portions (e.g., the second tab portions 421a of FIG. 13C) of each of the plurality of second electrode plates 420 may extend toward the second base electrode plate 420a in the same manner as the first tab portions 411a, and may be bundled together to be integrally welded at the (2-2)th portion 453.

According to an embodiment, the lead tabs (e.g., the first lead tab 440 and the second lead tab 450) may include bending portions (e.g., the first bending portion 447 and the second bending portion 457). The bending portions (e.g., the first bending portion 447 and the second bending portion 457) may be located outside the electrode assembly 401. The bending portions (e.g., the first bending portion 447 and the second bending portion 457) may connect the base electrode plates (e.g., the first base electrode plate 410a and the second base electrode plate 420a) to the first portions (e.g., the (1-1)th portion 441 and the (2-1)th portion 451). The bending portions may include a first bending portion 447 connecting the first base electrode plate 410a to the (1-1)th portion 441. The bending portions may include a second bending portion 457 connecting the second base electrode plate 420a to the (2-1)th portion (e.g., the (2-1)th portion 451 of FIG. 8). The (1-1)th portion 441 and the (2-1)th portion (e.g., the (2-1)th portion 451 of FIG. 8) may be located on substantially the same plane. An angle at which the first bending portion 447 is inclined with respect to the first base electrode plate 410a may differ from an angle at which the second bending portion 457 is inclined with respect to the second base electrode plate 420a. As the first base electrode plate 410a and the second base electrode plate 420a are spaced apart from each other with the separator 430 interposed therebetween, and the inclined angles of the first bending portion 447 and the second bending portion 457 differ from each other, the (1-1)th portion 441 and the (2-1)th portion (e.g., the (2-1)th portion 451 of FIG. 8) may be located on substantially the same plane.

FIGS. 11A to 15B may sequentially illustrate a method of manufacturing a battery cell 400 according to an embodiment of the disclosure. For example, after the structures illustrated in FIG. 11A are assembled, the structures illustrated in FIG. 11B may be assembled. For example, after assembling the structures illustrated in FIG. 11D, assembling the structures illustrated in FIG. 12A may be performed. However, the order of the method of manufacturing the battery cell 400 is not limited to the order described above and/or below, and the order of the manufacturing method of FIGS. 11A to 15B may be varied.

FIGS. 11A to 11D are diagrams illustrating a method for manufacturing an electrode plate pile 402 (see FIG. 11D) according to an embodiment of the disclosure. The electrode plate pile 402 according to an embodiment of the disclosure may be assembled and manufactured in the order shown in FIGS. 11A to 11D. FIG. 11A is a diagram illustrating one (e.g., a (1-1)th electrode plate 4101) of a plurality of first electrode plates 410 and a sheet 460 according to an embodiment of the disclosure. FIG. 11B is a diagram illustrating one (e.g., a (2-1)th electrode plate 4201) of a plurality of second electrode plates 420 and a sheet 460 stacked on the structure of FIG. 11A. FIG. 11C is a diagram illustrating one (e.g., a (1-2)th electrode plate 4102) of a plurality of first electrode plates 410 and a sheet 460 stacked on the structure of FIG. 11B. FIG. 11D is a diagram illustrating a plurality of first electrode plates 410 and a plurality of second electrode plates 420 stacked on the structure of FIG. 11C by alternately performing the manufacturing methods of FIGS. 11A and 11B. The components described with reference to FIGS. 11A to 11D may be partially or entirely the same as the components described with reference to FIGS. 1 to 10. The components described with reference to FIGS. 11A to 11D may be partially or entirely the same as the components described with reference to FIGS. 12A to 15B.

According to an embodiment, the electrode plate pile 402 may be manufactured during the process of manufacturing the battery cell 400. According to an embodiment of the disclosure, a process of manufacturing the electrode plate pile 402 may be referred to as a “first process.” The electrode plate pile 402 may be formed by assembling structures according to the order illustrated in FIGS. 11A to 11D.

According to an embodiment, the electrode plate pile 402 may include a plurality of first electrode plates 410. The electrode plate pile 402 may include a plurality of second electrode plates 420. The electrode plate pile 402 may include a plurality of sheets 460. The plurality of first electrode plates 410 and the plurality of second electrode plates 420 may be alternately arranged and stacked with each other. For example, each of the plurality of second electrode plates 420 may be disposed between each pair of first electrode plates 410. For example, each of the plurality of first electrode plates 410 may be disposed between each pair of second electrode plates 420. Each of the plurality of sheets 460 may be disposed between the first electrode plate 410 and the second electrode plate 420. Some of the plurality of sheets 460 may be detachably coupled to each of the plurality of first electrode plates 410, and the others may be detachably coupled to each of the plurality of second electrode plates 420. Each of the plurality of sheets 460 may correspond to one of a plurality of first electrode plates 410 separated from each other. Each of the plurality of sheets 460 may correspond to one of a plurality of second electrode plates 420 separated from each other.

According to an embodiment, the electrode plate pile 402 may be formed by stacking a plurality of first electrode plates 410. The electrode plate pile 402 may be formed by stacking a plurality of second electrode plates 420. A plurality of first electrode plates 410 may include a (1-1)th electrode plate 4101 and a (1-2)th electrode plate 4102. A plurality of second electrode plates 420 may include a (2-1)th electrode plate 4201 and a (2-2)th electrode plate 4202. The (1-1)th electrode plate 4101 and the (1-2)th electrode plate 4102 may be spaced apart from each other, and the (2-1)th electrode plate 4201 may be disposed between the (1-1)th electrode plate 4101 and the (1-2)th electrode plate 4102. The (2-1)th electrode plate 4201 and the (2-2)th electrode plate 4202 may be spaced apart from each other, and the (1-2)th electrode plate 4102 may be disposed between the (2-1)th electrode plate 4201 and the (2-2)th electrode plate 4202.

According to an embodiment, each of the plurality of first electrode plates 410 may include a first tab portion 411. Each of the plurality of first electrode plates 410 and each of the plurality of first tab portions may correspond to each other one-to-one. For example, a single first electrode plate 410 may include a single first tab portion (e.g., the (1-1)th tab portion 4111). The first tab portion 411 may protrude outward from the electrode plate pile 402. The (1-1)th electrode plate 4101 may include a (1-1)th tab portion 4111, and the (1-2)th electrode plate 4102 may include a (1-2)th tab portion 4112. The first electrode plate 410 disposed at the outermost side of the electrode plate pile 402 may include a first outermost tab portion 411n. The first tab portions of each of the plurality of first electrode plates 410 may be spaced apart from each other.

According to an embodiment, each of the plurality of second electrode plates 420 may include a second tab portion 421. Each of the plurality of second electrode plates 420 and each of the plurality of second tab portions may correspond to each other one-to-one. For example, a single second electrode plate 420 may include a single second tab portion (e.g., the (2-1)th tab portion 4211). The second tab portion 421 may protrude in a direction facing outward from the electrode plate pile 402. The (2-1)th electrode plate 4201 may include the (2-1)th tab portion 4211, and the (2-2)th electrode plate 4202 may include the (2-2)th tab portion 4212. The second electrode plate 420 disposed at the outermost side of the electrode plate pile 402 may include a second outermost tab portion 421n. The second tab portions of each of the plurality of second electrode plates 420 may be spaced apart from each other.

According to an embodiment, the (1-1)th electrode plate 4101 and the sheet 460 may be disposed as shown in FIG. 11A. The (1-1)th electrode plate 4101 may include the (1-1)th tab portion 4111. The process of arranging the (1-1)th electrode plate 4101 may be referred to as “(1-1)th process.”

According to an embodiment, as shown in FIG. 11B, the (2-1)th electrode plate 4201 and the sheet 460 may be stacked on the (1-1)th electrode plate 4101. The (2-1)th electrode plate 4201 may include the (2-1)th tab portion 4211. A process of stacking the (2-1)th electrode plate 4201 on the (1-1)th electrode plate 4101 may be referred to as a “(1-2)th process.” The (1-2)th process may be performed after the (1-1)th process. The first process (e.g., the process of FIGS. 11A to 11D) may include the (1-1)th process and the (1-2)th process.

According to an embodiment, as shown in FIG. 11C, the (1-2)th electrode plate 4102 and the sheet 460 may be stacked on the (2-1)th electrode plate 4201. The (1-2)th electrode plate 4102 may include a (1-2)th tab portion 4112. The (1-2)th tab portion 4112 may be spaced apart from the upper side of the (1-1)th tab portion 4111. A process of stacking the (1-2)th electrode plate 4102 on the (2-1)th electrode plate 4201 may be referred to as a “(1-3)th process.” The (1-3)th process may be performed after the (1-2)th process. The first process (e.g., the process of FIGS. 11A to 11D) may include the (1-1)th process, the (1-2)th process, and the (1-3)th process.

According to an embodiment, as shown in FIG. 11D, the electrode plate pile 402 may be formed by alternately repeating the (1-1)th process, the (1-2)th process, and the (1-3)th process. For example, after the (1-3)th process, the sheet 460 and the (2-2)th electrode plate 4202 may be stacked on the (1-2)th electrode plate 4102, and then the sheet 460 and the (1-3)th electrode plate may be stacked.

FIGS. 12A, 12B, and 12C are diagrams illustrating a process of welding the electrode plate pile 402 and the first base electrode plate 410a. FIG. 12A is a diagram illustrating a first base electrode plate 410a. FIG. 12B is a diagram illustrating the arrangement of the first base electrode plate 410a in such a way that at least a portion of the first base electrode plate 410a overlaps on one side of the electrode plate pile 402. FIG. 12C is a diagram illustrating a state in which a plurality of first tab portions 411 and a first lead tab 440 are welded to each other. The components described with reference to FIGS. 12A, 12B, and 12C may be partially or entirely the same as the components described with reference to FIGS. 1 to 11D. The components described with reference to FIGS. 12A, 12B, and 12C may be partially or entirely the same as the components described with reference to FIGS. 13A to 15B.

According to an embodiment, the first base electrode plate 410a may include a first body 412 and a first recess 413. The first body 412 may be a substantially flat plate. The first body 412 may include an active material. The first recess 413 may be formed in the first body 412. The first recess 413 may not include the active material. The first recess 413 may be defined as an area on the first base electrode plate 410a where the active material is not applied. The first lead tab 440 may be coupled to the first recess 413. The (1-2)th portion 443 may be coupled to (e.g., in) the first recess 413. The (1-1)th portion 441 may extend from the first recess 413 in a direction away from the first base electrode plate 410a. The first base electrode plate 410a may be referred to as a “base cathode body.”

According to an embodiment, during a process of manufacturing the battery cell 400, the plurality of first tab portions 411 of the electrode plate pile 402 and the first lead tab 440 of the first base electrode plate 410a may be welded to each other. According to an embodiment of the disclosure, the process of welding the first tab portions 411 and the first lead tab 440 may be referred to as a “second process.” The welding process for the first tab portions 411 and the first lead tab 440 may be performed in the order shown in FIGS. 12B and 12C (e.g., FIG. 12B and then FIG. 12C).

According to an embodiment, as shown in FIG. 12B, the first base electrode plate 410a may be disposed on one side of the electrode plate pile 402. The first base electrode plate 410a may be disposed such that a portion thereof vertically overlaps with the plurality of first tab portions 411. A plurality of first tab portions 411 may be aligned vertically with the (1-2)th portion 443 of the first lead tab 440. The process of placing the first base electrode plate 410a on one side of the electrode plate pile 402 may be referred to as a “(2-1)th process.” The second process (e.g., the process of FIGS. 12B and 12C) may include the (2-1)th process.

According to an embodiment, as shown in FIG. 12C, the plurality of first tab portions 411 may be welded to the (1-2)th portion 443. The first welding portion 444 may be formed by welding a plurality of first tab portions 411. The first base electrode plate 410a may provide a portion (e.g., the (1-2)th portion 443) to which a plurality of first tab portions 411 are welded. The (1-1)th portion 441 of the first lead tab 440 may be located below the electrode plate pile 402. The first lead tab 440 may include a first connection portion 446 connected to each of the plurality of first tab portions 411a. The first connection portion 446 may connect each of the plurality of first tab portions 411a with the (1-2)th portion 443. The process of welding the plurality of first tab portions 411 to the first base electrode plate 410a may be referred to as a “(2-2)th process.” The (2-2)th process may be performed after the (2-1)th process. The second process (e.g., the process of FIGS. 12B and 12C) may include the (2-1)th process and the (2-2)th process.

FIGS. 13A, 13B, and 13C are diagrams illustrating a process of welding the electrode plate pile 402 and the second base electrode plate 420a. FIG. 13A is a diagram illustrating a second base electrode plate 420a. FIG. 13B is a diagram illustrating the arrangement of the second base electrode plate 420a in such a way that at least a portion the second base electrode plate 420a overlaps on one side of the electrode plate pile 402. FIG. 13C is a diagram illustrating a state in which a plurality of second tab portions 421 and a second lead tab 450 are welded to each other. The components described with reference to FIGS. 13A, 13B, and 13C may be partially or entirely the same as the components described with reference to FIGS. 1 to 12C. The components described with reference to FIGS. 13A, 13B, and 13C may be partially or entirely the same as the components described with reference to FIGS. 14A to 15B.

According to an embodiment, the second base electrode plate 420a may include a second body 422 and a second recess 423. The second body 422 may be a substantially flat plate. The second body 422 may include an active material. The second recess 423 may be formed in the second body 422. The second recess 423 may not include the active material. The second recess 423 may be defined as an area on the second base electrode plate 420a where the active material is not applied. The second lead tab 450 may be coupled to the second recess 423. The (2-2)th portion 453 may be coupled to (e.g., in) the second recess 423. The (2-1)th portion 451 may extend from the second recess 423 in a direction away from the second base electrode plate 420a. The second base electrode plate 420a may be referred to as a “base anode body.”

According to an embodiment, during a process of manufacturing the battery cell 400, the plurality of second tab portions 421 of the electrode plate pile 402 and the second lead tab 450 of the second base electrode plate 420a may be welded to each other. According to an embodiment of the disclosure, the process of welding the second tab portions 421 and the second lead tab 450 may be referred to as a “third process.” The welding process for the second tab portions 421 and the second lead tab 450 may be performed in the order shown in FIGS. 13B and 13C (e.g., FIG. 13B and then FIG. 13C).

According to an embodiment, as shown in FIG. 13B, the second base electrode plate 420a may be disposed on one side of the electrode plate pile 402. The second base electrode plate 420a may be disposed such that a portion thereof vertically overlaps with the plurality of second tab portions 421. The plurality of second tab portions 421 may be aligned vertically with the (2-2)th portion 453 of the second lead tab 450. The process of placing the second base electrode plate 420a on one side of the electrode plate pile 402 may be referred to as “(3-1)th process.” The third process (e.g., the process of FIGS. 13B and 13C) may include the (3-1)th process.

According to an embodiment, as shown in FIG. 13C, the plurality of second tab portions 421 may be welded to the (2-2)th portion 453. The second welding portion 454 may be formed by welding a plurality of second tab portions 421. The second base electrode plate 420a may provide a portion (e.g., the (2-2)th portion 453) to which the plurality of second tab portions 421 are welded. The (2-1)th portion 451 of the second lead tab 450 may be located below the electrode plate pile 402. The second lead tab 450 may include a second connection portion 456 connected to each of the plurality of second tab portions 421a. The second connection portion 456 may connect each of the plurality of second tab portions 421a with the second-second portion 453. The process of welding the plurality of second tab portions 421 to the second base electrode plate 420a may be referred to as a “(3-2)th process.” The (3-2)th process may be performed after the (3-1)th process. The third process (e.g., the process of FIGS. 13B and 13C) may include the (3-1)th process and the (3-2)th process.

FIGS. 14A and 14B are diagrams illustrating the process of stacking a separator 430 onto an electrode plate (e.g., the second base electrode plate 420a). FIG. 14A is a diagram before the separator 430 is stacked onto the electrode plate (e.g., the second base electrode plate 420a), and FIG. 14B is a diagram after the separator 430 has been stacked onto the electrode plate (e.g., the second base electrode plate 420a). The components described with reference to FIGS. 14A and 14B may be partially or entirely the same as the components described with reference to FIGS. 1 to 13C. The components described with reference to FIGS. 14A and 14B may be partially or entirely the same as the components described with reference to FIGS. 15A and 15B.

According to an embodiment, during a process of manufacturing the battery cell 400, the separator 430 may be stacked on the electrode plate (e.g., the second base electrode plate 420a). According to an embodiment of the disclosure, the process of stacking the separator 430 on the electrode plate (e.g., the second base electrode plate 420a) may be referred to as a “fourth process.” The process of stacking the electrode plate (e.g., the second base electrode plate 420a) and the separator 430 may be performed in the order shown in FIGS. 14A and 14B (e.g., FIG. 14A and then FIG. 14B). The fourth process may be performed after the third process (e.g., after the (3-2)th process shown in FIG. 13C).

According to an embodiment, as shown in FIG. 14A, the separator 430 may be disposed between the second base electrode plate 420a and the first base electrode plate (e.g., the first base electrode plate 410a of FIG. 12C). The separator 430 may extend longitudinally to one side from the space between the first base electrode plate 410a and the second base electrode plate 420a. The process of placing the separator 430 between the first base electrode plate 410a and the second base electrode plate 420a may be referred to as a “(4-1)th process.” The fourth process (e.g., the process illustrated in FIGS. 14A and 14B) may include the (4-1)th process.

According to an embodiment, as shown in FIG. 14B, the separator 430 may be stacked on the second base electrode plate 420a. The separator 430 may be folded in a first direction (e.g., the first direction F1 of FIG. 14A) in the state of FIG. 14A. The separator 430 may be folded in the first direction F1 so that a portion thereof may be stacked on the upper side of the second base electrode plate 420a. The separator 430 may include a first separator 431 located outside the second base electrode plate 420a and a second separator 432 stacked on the second base electrode plate 420a. The process of folding the separator 430 and stacking the separator 430 onto an electrode plate (e.g., the second base electrode plate 420a) may be referred to as a “(4-2)th process.” The fourth process (e.g., the process illustrated in FIGS. 14A and 14B) may include the (4-1)th process and the (4-2)th process.

FIGS. 15A and 15B are diagrams illustrating the process of folding the electrode plates (e.g., the first electrode plate 410 and the second electrode plate 420) of the electrode plate pile 402 to manufacture a battery cell (e.g., the battery cell 400 of FIG. 9). FIG. 15A is a diagram after folding the first electrode plate 410 of the electrode plate pile 402 toward the separator 430, and FIG. 15B is a diagram illustrating the separator 430 stacked on the first electrode plate 410 illustrated in FIG. 15A. The components described with reference to FIGS. 15A and 15B may be partially or entirely the same as those described with reference to FIGS. 1 to 14B.

According to an embodiment, during the process of manufacturing the battery cell 400, the electrode plates (e.g., the first electrode plate 410 and the second electrode plate 420) of the electrode plate pile 402 and the separator 430 may be alternately folded to manufacture the battery cell 400. According to an embodiment of the disclosure, the process of alternately and repeatedly folding the electrode plates (e.g., the first electrode plate 410 and the second electrode plate 420) of the electrode plate pile 402 and the separator 430 may be referred to as a “fifth process.” The process of alternately and repeatedly folding the electrode plates (e.g., the first electrode plate 410 and the second electrode plate 420) of the electrode plate pile 402 and the separator 430 may be performed in the order shown in FIGS. 15A and 15B (e.g., FIG. 15A and then FIG. 15B). The fifth process may be performed after the fourth process (e.g., after the (4-2)th process illustrated in FIG. 14B).

According to an embodiment, as shown in FIG. 15A, the first electrode plate 410 of the electrode plate pile 402 may be stacked on the separator 430. The first electrode plate 410 of the electrode plate pile 402 may be folded in a second direction (e.g., the second direction F2 of FIG. 14B) from the electrode plate pile 402 and stacked on the separator 430. The process of folding the electrode plate (e.g., the first electrode plate 410) of the electrode plate pile 402 and stacking the electrode plate onto the separator 430 may be referred to as a “(5-1)th process.” The fifth process (e.g., the process illustrated in FIGS. 15A and 15B) may include the (5-1)th process. After the electrode plate (e.g., the first electrode plate 410) of the electrode plate pile 402 is folded, the sheet 460 may be removed. The sheet 460 that was coupled to the first electrode plate 410 stacked on the separator 430 may be removed from the electrode plate pile 402. The sheet 460 may be removed by applying force in a third direction F3 from the electrode plate pile 402. After the sheet 460 is removed, an electrode plate (e.g., the second electrode plate 420) different from the electrode plate (e.g., the first electrode plate 410) stacked on the separator 430 may be exposed to the outside of the electrode plate pile 402.

According to an embodiment, as shown in FIG. 15B, the separator 430 may be folded to stack a portion of the separator 430 onto the first electrode plate 410. As illustrated in FIG. 15A, in a state in which the first electrode plate 410 is stacked on the separator 430, the separator 430 may be folded in a fourth direction F4 and stacked on the first electrode plate 410. The separator 430 may include a first separator 431 located outside the first electrode plate 410 and a second separator 432 stacked on the second electrode plate 420. The process of folding the separator 430 and stacking the separator 430 onto an electrode plate (e.g., the first electrode plate 410) may be referred to as a “(5-2)th process.” The (5-2)th process may be performed after the (5-1)th process. The fifth process (e.g., the process illustrated in FIGS. 15A and 15B) may include the (5-1)th process and the (5-2)th process.

According to an embodiment, following the (5-2)th process, the first electrode plate 410 of the electrode plate pile 402 may be folded in a fifth direction F5 and stacked on the separator 430 in a manner similar to that shown in FIG. 15A, and the sheet 460 may be removed. After the first electrode plate 410 is stacked on the separator 430, the separator 430 may be folded in a sixth direction F6 and stacked on the first electrode plate 410.

A battery cell (e.g., the battery cell 400 of FIG. 9) according to an embodiment of the disclosure may be formed by repeating the fifth process described with reference to FIGS. 15A and 15B. For example, the method of manufacturing the battery cell 400 may include a first step of folding the electrode plate (e.g., the first electrode plate 410 or the second electrode plate 420) from the electrode plate pile 402 and stacking it onto the second separator 432, and a second step of folding the first separator 431 and stacking it onto the electrode plate (e.g., the first electrode plate 410 or the second electrode plate 420) that has been stacked onto the second separator 432. The battery cell 400 may be manufactured by alternately repeating the first step and the second step. During the process in which the first step and the second step are repeated, a cell unit 403, which is a part of the battery cell 400, may be formed. The cell unit 403 may include at least one first electrode plate 410, at least one second electrode plate 420, and at least one separator 430.

According to an embodiment, a battery cell (e.g., the battery cell 400 of FIG. 9) may be manufactured through the first to fifth processes described with reference to FIGS. 11A to 15B. The battery cell (e.g., the battery cell 400 of FIG. 9) according to an embodiment of the disclosure may be manufactured by the first to fifth processes described above, thereby forming welding portions (e.g., the first welding portion 444 and the second welding portion 454 of FIG. 8) inside the electrode assembly (e.g., the electrode assembly 401 of FIG. 8).

According to a comparative example, a battery cell, in which the welding portion is located outside the electrode assembly, experiences a reduction in size and capacity of the battery by the volume occupied by the folded lead tab due to the structure of folding and welding the lead tab located outside the electrode assembly. However, the battery cell 400 according to an embodiment of the disclosure may increase the size and capacity of the battery by placing welding portions (e.g., the first welding portion 444 and the second welding portion 454 of FIG. 8) inside the electrode assembly 401.

Electronic devices include a battery for supplying power to electrical components. The battery includes an electrode assembly in which a plurality of negative electrode plates, a plurality of positive electrode plates, and a plurality of separators are stacked together. To achieve electrical coupling among the plurality of electrode plates constituting the electrode assembly, tab portions of each of the plurality of electrode plates are coupled through welding.

An aspect of the disclosure may be to position welding portions, where a plurality of electrode plates are coupled, inside the electrode assembly.

Another aspect of the disclosure may be to simplify the manufacturing process of the battery cell.

The solutions to the problems that are solved by embodiments the disclosure are not limited to the above-mentioned ones, and may include other solutions without departing from the scope and spirit of the disclosure.

Various embodiments of the disclosure may enable an electronic device to reduce the size of the battery and increase the capacity of the battery by positioning the welding portions, where the plurality of electrode plates are coupled, inside the electrode assembly.

Various embodiments of the disclosure may enable an electronic device to form welding portions by manufacturing an electrode plate pile where a plurality of electrode plates are stacked, and then to manufacture a battery cell including a separator, thereby allowing for positioning the welding portions of the battery cell inside the electrode assembly.

Effects obtainable from the disclosure are not limited to the above-described ones, and other unmentioned effects may be clearly understood by those skilled in the art from the above and below description.

The battery (e.g., the battery 350 of FIG. 5) according to an embodiment of the disclosure may include an electrode assembly (e.g., the electrode assembly 401 of FIGS. 8 to 15B).

The battery (e.g., the battery 350 of FIG. 5) according to an embodiment of the disclosure may include lead tabs (e.g., the first lead tab 440 and the second lead tab 450 of FIGS. 8 to 15B) at least partially extending outward from the electrode assembly (e.g., the electrode assembly 401 of FIGS. 8 to 15B).

The electrode assembly (e.g., the electrode assembly 401 of FIGS. 8 to 15B) according to an embodiment of the disclosure may include a plurality of first electrode plates (e.g., the first electrode plates 410 of FIGS. 8 to 15B).

The electrode assembly (e.g., the electrode assembly 401 of FIGS. 8 to 15B) according to an embodiment of the disclosure may include a plurality of second electrode plates (e.g., the second electrode plates 420 of FIGS. 8 to 15B) alternately arranged with the plurality of first electrode plates (e.g., the first electrode plates 410 of FIGS. 8 to 15B).

The electrode assembly (e.g., the electrode assembly 401 of FIGS. 8 to 15B) according to an embodiment of the disclosure may include a plurality of separators (e.g., the separators 430 of FIGS. 8 to 15B) disposed between the plurality of first electrode plates (e.g., the first electrode plates 410 of FIGS. 8 to 15B) and the plurality of second electrode plates (e.g., the second electrode plates 420 of FIGS. 8 to 15B), which are alternately arranged with each other.

The lead tabs (e.g., the first lead tab 440 or the second lead tab 450 of FIGS. 8 to 15B) according to an embodiment of the disclosure may include a first portion (e.g., the (1-1)th portion 441 or the (2-1)th portion 451 of FIGS. 8 to 15B) extending outward from the electrode assembly (e.g., the electrode assembly 401 of FIGS. 8 to 15B).

The lead tabs (e.g., the first lead tab 440 or the second lead tab 450 of FIGS. 8 to 15B) according to an embodiment of the disclosure may extend from the first portion (e.g., the (1-1)th portion 441 or the (2-1)th portion 451 of FIGS. 8 to 15B) between the plurality of separators (e.g., the separators 430 of FIGS. 8 to 15B) and may include a second portion (e.g., the (1-2)th portion 443 or the (2-2)th portion 453 of FIGS. 8 to 15B) that is formed with welding portions (e.g., the first welding portion 444 or the second welding portion 454 of FIGS. 8 to 15B) disposed between the plurality of separators (e.g., the separators 430 of FIGS. 8 to 15B).

The lead tabs (e.g., the first lead tab 440 or the second lead tab 450 of FIGS. 8 to 15B) according to an embodiment of the disclosure may include a second portion (e.g., the (1-2)th portion 443 or the (2-2)th portion 453 of FIGS. 8 to 15B) extending from the first portion (e.g., the (1-1)th portion 441 or the (2-1)th portion 451 of FIGS. 8 to 15B) and having at least one surface formed with welding portions (e.g., the first welding portion 444 or the second welding portion 454 of FIGS. 8 to 15B), which faces at least one of the plurality of separators (e.g., the separators 430 of FIGS. 8 to 15B).

The welding portions (e.g., the first welding portion 444 or the second welding portion 454 of FIGS. 8 to 15B) according to an embodiment of the disclosure may include a first welding portion (e.g., the first welding portion 444 of FIGS. 8 to 15B) welded to at least one of the plurality of first electrode plates (e.g., the first electrode plates 410 of FIGS. 8 to 15B).

The welding portions (e.g., the first welding portion 444 or the second welding portion 454 of FIGS. 8 to 15B) according to an embodiment of the disclosure may include a second welding portion (e.g., the second welding portion 454 of FIGS. 8 to 15B) welded to at least one of the plurality of second electrode plates (e.g., the second electrode plates 420 of FIGS. 8 to 15B).

The welding portions (e.g., the first welding portion 444 or the second welding portion 454 of FIGS. 8 to 15B) according to an embodiment of the disclosure may include a first welding portion (e.g., the first welding portion 444 of FIGS. 8 to 15B) to which first tab portions (e.g., the first tab portions 411 of FIGS. 8 to 15B) of each of the plurality of first electrode plates (e.g., the first electrode plates 410 of FIGS. 8 to 15B) are welded.

The welding portions (e.g., the first welding portion 444 and the second welding portion 454 of FIGS. 8 to 15B) according to an embodiment of the disclosure may include a second welding portion (e.g., the second welding portion 454 of FIGS. 8 to 15B) to which second tab portions (e.g., the second tab portions 421 of FIGS. 8 to 15B) of each of the plurality of second electrode plates (e.g., the second electrode plates 420 of FIGS. 8 to 15B) are welded.

The lead tabs (e.g., the first lead tab 440 or the second lead tab 450 of FIGS. 8 to 15B) according to an embodiment of the disclosure may include a first connection portion (e.g., the first connection portion 446 of FIGS. 8 to 15B) connecting the first tab portions (e.g., the first tab portions 411 of FIGS. 8 to 15B) with the first welding portion (e.g., the first welding portion 444 of FIGS. 8 to 15B).

The lead tabs (e.g., the first lead tab 440 or the second lead tab 450 of FIGS. 8 to 15B) according to an embodiment of the disclosure may include a second connection portion (e.g., the second connection portion 456 of FIGS. 8 to 15B) connecting the second tab portions (e.g., the second tab portions 421 of FIGS. 8 to 15B) with the second welding portion (e.g., the second welding portion 454 of FIGS. 8 to 15B).

The lead tabs (e.g., the first lead tab 440 or the second lead tab 450 of FIGS. 8 to 15B) according to an embodiment of the disclosure may include a first lead tab (e.g., the first lead tab 440 of FIGS. 8 to 15B) including a (1-1)th portion (e.g., the (1-1)th portion 441 of FIGS. 8 to 15B) located outside the electrode assembly (e.g., the electrode assembly 401 of FIGS. 8 to 15B) and a (1-2)th portion (e.g., the (1-2)th portion 443 of FIGS. 8 to 15B) in which the first welding portion (e.g., the first welding portion 444 of FIGS. 8 to 15B) is formed.

The lead tabs (e.g., the first lead tab 440 or the second lead tab 450 in FIGS. 8 to 15B) according to an embodiment of the disclosure may include a second lead tab (e.g., the second lead tab 450 in FIGS. 8 to 15B) including a (2-1)th portion (e.g., the (2-1)th portion 451 in FIGS. 8 to 15B) located outside the electrode assembly (e.g., the electrode assembly 401 in FIGS. 8 to 15B) and a (2-2)th portion (e.g., the (2-2)th portion 453 in FIGS. 8 to 15B) in which the second welding portion (e.g., the second welding portion 454 in FIGS. 8 to 15B) is formed.

The plurality of first electrode plates (e.g., the first electrode plates 410 of FIGS. 8 to 15B) according to an embodiment of the disclosure may include a first base electrode plate (e.g., the first base electrode plates 410a of FIGS. 8 to 15B) on which the first welding portion (e.g., the first welding portion 444 of FIGS. 8 to 15B) is formed.

The plurality of second electrode plates (e.g., the second electrode plates 420 of FIGS. 8 to 15B) according to an embodiment of the disclosure may include a second base electrode plate (e.g., the second base electrode plate 420a of FIGS. 8 to 15B) on which the second welding portion (e.g., the second welding portion 454 of FIGS. 8 to 15B) is formed.

The lead tabs (e.g., the first lead tab 440 or the second lead tab 450 of FIGS. 8 to 15B) according to an embodiment of the disclosure may include a bending portion (e.g., the first bending portion 447 or the second bending portion 457 of FIGS. 8 to 15B) connecting the first portion (e.g., the (1-1)th portion 441 or the (2-1)th portion 451 of FIGS. 8 to 15B) with the second portion (e.g., the (1-2)th portion 443 or the (2-2)th portion 453 of FIGS. 8 to 15B).

The lead tabs (e.g., the first lead tab 440 or the second lead tab 450 of FIGS. 8 to 15B) according to an embodiment of the disclosure may include a first lead tab (e.g., the first lead tab 440 of FIGS. 8 to 15B) that includes a (1-1)th portion (e.g., the (1-1)th portion 441 of FIGS. 8 to 15B) located outside the electrode assembly (e.g., the electrode assembly 401 of FIGS. 8 to 15B), a (1-2)th portion (e.g., the (1-2)th portion 443 of FIGS. 8 to 15B) located inside the electrode assembly (e.g., the electrode assembly 401 of FIGS. 8 to 15B), and a first bending portion (e.g., the first bending portion 447 of FIGS. 8 to 15B) connecting the (1-1)th portion (e.g., the (1-1)th portion 441 of FIGS. 8 to 15B) with the (1-2)th portion (e.g., the (1-2)th portion 443 of FIGS. 8 to 15B).

The lead tabs (e.g., the first lead tab 440 or the second lead tab 450 of FIGS. 8 to 15B) according to an embodiment of the disclosure may include a second lead tab (e.g., the second lead tab 450 of FIGS. 8 to 15B) that includes a (2-1)th portion (e.g., the (2-1)th portion 451 of FIGS. 8 to 15B) located outside the electrode assembly (e.g., the electrode assembly 401 of FIGS. 8 to 15B), a (2-2)th portion (e.g., the (2-2)th portion 453 of FIGS. 8 to 15B) located inside the electrode assembly (e.g., the electrode assembly 401 of FIGS. 8 to 15B), and a second bending portion (e.g., the second bending portion 457 of FIGS. 8 to 15B) connecting the (2-1)th portion (e.g., the (2-1)th portion 451 of FIGS. 8 to 15B) with the (2-2)th portion (e.g., the (2-2)th portion 453 of FIGS. 8 to 15B).

According to an embodiment of the disclosure, the angles at which the first bending portion (e.g., the first bending portion 447 of FIGS. 8 to 15B) and the second bending portion (e.g., the second bending portion 457 of FIGS. 8 to 15B) are inclined may be different from each other.

A method of manufacturing a battery (e.g., the battery 350 of FIG. 5) according to an embodiment of the disclosure may include a first process of manufacturing an electrode plate pile (e.g., the electrode plate pile 402 of FIGS. 8 to 15B) in which the plurality of first electrode plates (e.g., the first electrode plates 410 of FIGS. 8 to 15B) and the plurality of second electrode plates (e.g., the second electrode plates 420 of FIGS. 8 to 15B) are stacked.

A method of manufacturing a battery (e.g., the battery 350 of FIG. 5) according to an embodiment of the disclosure may include a second process of welding first tab portions (e.g., the first tab portions 411 of FIGS. 8 to 15B) of each of the plurality of first electrode plates (e.g., the first electrode plates 410 of FIGS. 8 to 15B) to a first base electrode plate (e.g., the first base electrode plates 410a of FIGS. 8 to 15B), which is one of the plurality of first electrode plates (e.g., the first electrode plates 410 of FIGS. 8 to 15B).

A method of manufacturing a battery (e.g., the battery 350 of FIG. 5) according to an embodiment of the disclosure may include a third process of welding second tab portions (e.g., the second tab portions 421 of FIGS. 8 to 15B) of each of the plurality of second electrode plates (e.g., the second electrode plates 420 of FIGS. 8 to 15B) to a second base electrode plate (e.g., the second base electrode plate 420a of FIGS. 8 to 15B), which is one of the plurality of second electrode plates (e.g., the second electrode plates 420 of FIGS. 8 to 15B).

An order between the second process and the third process according to an embodiment of the disclosure may be switchable with each other.

A method of manufacturing a battery (e.g., the battery 350 in FIG. 5) according to an embodiment of the disclosure may include a fourth process of placing the separator (e.g., the separator 430 in FIGS. 8 to 15B) between the first base electrode plate (e.g., the first base electrode plate 410a in FIGS. 8 to 15B) and the second base electrode plate (e.g., the second base electrode plate 420a in FIGS. 8 to 15B), and folding and stacking the separator (e.g., the separator 430 in FIGS. 8 to 15B) on the first base electrode plate (e.g., the first base electrode plate 410a in FIGS. 8 to 15B) or the second base electrode plate (e.g., the second base electrode plate 420a in FIGS. 8 to 15B).

A method of manufacturing a battery (e.g., the battery 350 of FIG. 5) according to an embodiment of the disclosure may include a fifth process of stacking any one of the plurality of first electrode plates (e.g., the first electrode plates 410 of FIGS. 8 to 15B) included in the electrode plate pile (e.g., the electrode plate pile 402 of FIGS. 8 to 15B) or any one of the plurality of second electrode plates (e.g., the second electrode plates 420 of FIGS. 8 to 15B) included in the electrode plate pile (e.g., the electrode plate pile 402 of FIGS. 8 to 15B) onto the separator (e.g., the separator 430 of FIGS. 8 to 15B).

A battery (e.g., the battery 350 in FIG. 5) according to an embodiment of the disclosure may include a battery cell (e.g., the battery cell 400 in FIGS. 8 to 15B) including the electrode assembly (e.g., the electrode assembly 401 in FIGS. 8 to 15B) and the lead tabs (e.g., the first lead tab 440 and the second lead tab 450 in FIGS. 8 to 15B).

A method of manufacturing a battery (e.g., the battery 350 of FIG. 5) according to an embodiment of the disclosure may include a first process of manufacturing an electrode plate pile (e.g., the electrode plate pile 402 of FIGS. 8 to 15B) including a plurality of first electrode plates (e.g., the first electrode plates 410 of FIGS. 8 to 15B) and a plurality of second electrode plates (e.g., the second electrode plates 420 of FIGS. 8 to 15B) arranged alternately with the plurality of first electrode plates (e.g., the first electrode plates 410 of FIGS. 8 to 15B).

A method of manufacturing a battery (e.g., the battery 350 of FIG. 5) according to an embodiment of the disclosure may include a second process of placing a first base electrode plate (e.g., the first base electrode plates 410a of FIGS. 8 to 15B) to which a first lead tab (e.g., the first lead tab 440 of FIGS. 8 to 15B) is coupled, on one side of the electrode plate pile (e.g., the electrode plate pile 402 of FIGS. 8 to 15B), and welding the first lead tab (e.g., the first lead tab 440 of FIGS. 8 to 15B) to first tab portions (e.g., the first tab portions 411 of FIGS. 8 to 15B) of each of the plurality of first electrode plates (e.g., the first electrode plates 410 of FIGS. 8 to 15B).

A method of manufacturing a battery (e.g., the battery 350 in FIG. 5) according to an embodiment of the disclosure may include a third process of placing a second base electrode plate (e.g., the second base electrode plate 420a in FIGS. 8 to 15B) to which a second lead tab (e.g., the second lead tab 450 in FIGS. 8 to 15B) is coupled, on one side of the electrode plate pile (e.g., the electrode plate pile 402 in FIGS. 8 to 15B), and welding the second lead tab (e.g., the second lead tab 450 in FIGS. 8 to 15B) to second tab portions (e.g., the second tab portions 421 in FIGS. 8 to 15B) of each of the plurality of second electrode plates (e.g., the second electrode plates 420 in FIGS. 8 to 15B).

According to an embodiment of the disclosure, the first lead tab (e.g., the first lead tab 440 of FIGS. 8 to 15B) may include a first welding portion (e.g., the first welding portion 444 of FIGS. 8 to 15B) to which the first tab portions (e.g., the first tab portions 411 of FIGS. 8 to 15B) are welded, and the second lead tab (e.g., the second lead tab 450 of FIGS. 8 to 15B) may include a second welding portion (e.g., the second welding portion 454 of FIGS. 8 to 15B) to which the second tab portions (e.g., the second tab portions 421 of FIGS. 8 to 15B) are welded.

A method of manufacturing a battery (e.g., the battery 350 in FIG. 5) according to an embodiment of the disclosure may include a fourth process of placing a separator (e.g., the separator 430 in FIGS. 8 to 15B) between the first base electrode plate (e.g., the first base electrode plate 410a in FIGS. 8 to 15B) and the second base electrode plate (e.g., the second base electrode plate 420a in FIGS. 8 to 15B), and folding and stacking the separator (e.g., the separator 430 in FIGS. 8 to 15B) on the first base electrode plate (e.g., the first base electrode plate 410a in FIGS. 8 to 15B) or the second base electrode plate (e.g., the second base electrode plate 420a in FIGS. 8 to 15B).

A method of manufacturing a battery (e.g., the battery 350 of FIG. 5) according to an embodiment of the disclosure may include a fifth process of stacking any one of the plurality of first electrode plates (e.g., the first electrode plates 410 of FIGS. 8 to 15B) included in the electrode plate pile (e.g., the electrode plate pile 402 of FIGS. 8 to 15B) or any one of the plurality of second electrode plates (e.g., the second electrode plates 420 of FIGS. 8 to 15B) included in the electrode plate pile (e.g., the electrode plate pile 402 of FIGS. 8 to 15B) onto the separator (e.g., the separator 430 of FIGS. 8 to 15B).

An electronic device (e.g., the electronic device 101 of FIG. 5) according to an embodiment of the disclosure may include a housing (e.g., the housing 301 of FIG. 5).

An electronic device (e.g., the electronic device 101 of FIG. 5) according to an embodiment of the disclosure may include a battery (e.g., the battery 350 of FIG. 5) disposed inside the housing (e.g., the housing 301 of FIG. 5) and including an electrode assembly (e.g., the electrode assembly 401 of FIGS. 8 to 15B) and lead tabs (e.g., the first lead tab 440 and the second lead tab 450 of FIGS. 8 to 15B) at least partially extending outward from the electrode assembly (e.g., the electrode assembly 401 of FIGS. 8 to 15B).

A battery (e.g., the battery 350 of FIGS. 1 to 15B) according to an embodiment of the disclosure may include a plurality of negative electrodes (e.g., the first electrode plates 410 of FIGS. 1 to 15B) including a negative electrode (e.g., the first electrode plates 410 of FIGS. 1 to 15B) having a first tab portion (e.g., the first tab portions 411 of FIGS. 1 to 15B) and a negative electrode current collector (e.g., the first base electrode plates 410a of FIGS. 1 to 15B) including a first recess (e.g., the first recess 413 of FIGS. 1 to 15B) and a first lead tab (e.g., the first lead tab 440 of FIGS. 1 to 15B) disposed in the first recess (e.g., the first recess 413 of FIGS. 1 to 15B).

A battery (e.g., the battery 350 of FIGS. 1 to 15B) according to an embodiment of the disclosure may include a positive electrode (e.g., the second electrode plates 420 of FIGS. 1 to 15B) having a second tab portion (e.g., the second tab portions 421 of FIGS. 1 to 15B) and a positive electrode current collector (e.g., the second base electrode plate 420a of FIGS. 1 to 15B) including a second recess (e.g., the second recess 423 of FIGS. 1 to 15B) and a second lead tab (e.g., the second lead tab 450 of FIGS. 1 to 15B) disposed in the second recess (e.g., the second recess 423 of FIGS. 1 to 15B), and may include a plurality of positive electrodes (e.g., the second electrode plates 420 of FIGS. 1 to 15B) arranged alternately with the plurality of negative electrodes (e.g., the first electrode plates 410 of FIGS. 1 to 15B).

A battery (e.g., the battery 350 of FIGS. 1 to 15B) according to an embodiment may include a separator (e.g., the separator 430 of FIGS. 1 to 15B) disposed between each pair of adjacent electrodes among the plurality of negative electrodes (e.g., the first electrode plates 410 of FIGS. 1 to 15B) and the plurality of positive electrodes (e.g., the second electrode plates 420 of FIGS. 1 to 15B).

A first tab portion (e.g., the first tab portion 411 of FIGS. 1 to 15B) of a negative electrode (e.g., the first electrode plate 410 of FIGS. 1 to 15B) according to an embodiment of the disclosure may be welded to the first lead tab (e.g., the first lead tab 440 of FIGS. 1 to 15B) to form a first welding portion (e.g., the first welding portion 444 of FIGS. 1 to 15B) which is located in the first recess (e.g., the first recess 413 of FIGS. 1 to 15B) of the negative electrode current collector (e.g., the first base electrode plates 410a of FIGS. 1 to 15B).

A second tab portion (e.g., the second tab portion 421 of FIGS. 1 to 15B) of a positive electrode (e.g., the second electrode plate 420 of FIGS. 1 to 15B) according to an embodiment of the disclosure may be welded to the second lead tab (e.g., the second lead tab 450 of FIGS. 1 to 15B) to form a second welding portion (e.g., the second welding portion 454 of FIGS. 1 to 15B) which is located in the second recess (e.g., the second recess 423 of FIGS. 1 to 15B) of the positive electrode current collector (e.g., the second base electrode plate 420a of FIGS. 1 to 15B).

According to an embodiment of the disclosure, the first lead tab (e.g., the first lead tab 440 of FIGS. 1 to 15B) may include a (1-1)th portion (e.g., the (1-1)th portion 441 of FIGS. 1 to 15B) extending outward from the plurality of negative electrodes (e.g., the first electrode plates 410 of FIGS. 1 to 15B).

According to an embodiment of the disclosure, the first lead tab (e.g., the first lead tab 440 of FIGS. 1 to 15B) may include a (1-2)th portion (e.g., the (1-2)th portion 443 of FIGS. 1 to 15B) coupled to the first recess (e.g., the first recess 413 of FIGS. 1 to 15B) and having the first welding portion (e.g., the first welding portion 444 of FIGS. 1 to 15B) formed thereon.

According to an embodiment of the disclosure, the second lead tab (e.g., the second lead tab 450 of FIGS. 1 to 15B) may include a (2-1)th portion (e.g., the (2-1)th portion 451 of FIGS. 1 to 15B) extending outward from the plurality of positive electrodes (e.g., the second electrode plates 420 of FIGS. 1 to 15B).

According to an embodiment of the disclosure, the second lead tab (e.g., the second lead tab 450 of FIGS. 1 to 15B) may include a (2-2)th portion (e.g., the (2-2)th portion 453 of FIGS. 1 to 15B) coupled to the second recess (e.g., the second recess 423 of FIGS. 1 to 15B) and having the second welding portion (e.g., the second welding portion 454 of FIGS. 1 to 15B).

The (1-1)th portion (e.g., the (1-1)th portion 441 of FIGS. 1 to 15B) according to an embodiment of the disclosure may extend from the (1-2)th portion (e.g., the (1-2)th portion 443 of FIGS. 1 to 15B) in a direction away from the first recess (e.g., the first recess 413 of FIGS. 1 to 15B).

The (2-1)th portion (e.g., the (2-1)th portion 451 of FIGS. 1 to 15B) according to an embodiment of the disclosure may extend from the (2-2)th portion (e.g., the (2-2)th portion 453 of FIGS. 1 to 15B) in a direction away from the second recess (e.g., the second recess 423 of FIGS. 1 to 15B).

A battery (e.g., the battery 350 of FIGS. 1 to 15B) according to an embodiment of the disclosure may include an electrode assembly (e.g., the electrode assembly 401 of FIGS. 1 to 15B) formed by stacking the plurality of negative electrodes (e.g., the first electrode plates 410 of FIGS. 1 to 15B) and the plurality of positive electrodes (e.g., the second electrode plates 420 of FIGS. 1 to 15B).

The first welding portion (e.g., the first welding portion 444 of FIGS. 1 to 15B) and the second welding portion (e.g., the second welding portion 454 of FIGS. 1 to 15B) according to an embodiment of the disclosure may be located inside the electrode plate assembly (e.g., the electrode assembly 401 of FIGS. 1 to 15B).

At least a portion of the separator (e.g., the separator 430 of FIGS. 1 to 15B) according to an embodiment of the disclosure may be disposed between the negative electrode current collector (e.g., the first base electrode plates 410a of FIGS. 1 to 15B) and the positive electrode current collector (e.g., the second base electrode plate 420a of FIGS. 1 to 15B).

At least a portion of the separator (e.g., the separator 430 of FIGS. 1 to 15B) according to an embodiment of the disclosure may be disposed between the first welding portion (e.g., the first welding portion 444 of FIGS. 1 to 15B) and the second welding portion (e.g., the second welding portion 454 of FIGS. 1 to 15B).

A first recess (e.g., the first recess 413 of FIGS. 1 to 15B) according to an embodiment of the disclosure may be formed by being recessed from a first body (e.g., the first body 412 of FIGS. 1 to 15B) of a negative electrode current collector (e.g., the first base electrode plates 410a of FIGS. 1 to 15B) including an active material.

A second recess (e.g., the second recess 423 of FIGS. 1 to 15B) according to an embodiment of the disclosure may be formed by being recessed from a second body (e.g., the second body 422 of FIGS. 1 to 15B) of a positive electrode current collector (e.g., the second base electrode plate 420a of FIGS. 1 to 15B) including an active material.

The first tab portion (e.g., the first tab portion 411 of FIGS. 1 to 15B) and the second tab portion (e.g., the second tab portion 421 of FIGS. 1 to 15B) according to an embodiment of the disclosure may be bent at an end of the separator (e.g., the separator 430 of FIGS. 1 to 15B).

A separator (e.g., the separator 430 of FIGS. 1 to 15B) according to an embodiment of the disclosure may include a separator end region (e.g., the separator end region 436 of FIGS. 1 to 15B) on which the first tab portion (e.g., the first tab portion 411 of FIGS. 1 to 15B) or the second tab portion (e.g., the second tab portion 421 of FIGS. 1 to 15B) is at least partially mounted.

A battery (e.g., the battery 350 of FIGS. 1 to 15B) according to an embodiment of the disclosure may include a battery cell (e.g., the battery cell 400 of FIGS. 1 to 15B) including the plurality of negative electrodes (e.g., the first electrode plates 410 of FIGS. 1 to 15B), the plurality of positive electrodes (e.g., the second electrode plates 420 of FIGS. 1 to 15B), the separator (e.g., the separator 430 of FIGS. 1 to 15B), the first lead tab (e.g., the first lead tab 440 of FIGS. 1 to 15B), and the second lead tab (e.g., the second lead tab 450 of FIGS. 1 to 15B).

While non-limiting example embodiments of the disclosure has been shown and described, it will be understood by those skilled in the art that various variations in form and details may be made therein without departing from the spirit and scope of the disclosure.

What is claimed is:

1. A battery comprising:
a plurality of negative electrodes comprising:
a negative electrode including a first tab portion; and
a negative electrode current collector including a first recess;
a plurality of positive electrodes arranged alternately with the plurality of negative electrodes, the plurality of positive electrodes comprising:
a positive electrode including a second tab portion; and
a positive electrode current collector including a second recess;
a separator disposed at positions between two adjacent electrodes among the plurality of negative electrodes and the plurality of positive electrodes;
a first lead tab in the first recess of the negative electrode current collector; and
a second lead tab in the second recess of the positive electrode current collector,
wherein the first tab portion of the negative electrode is welded to the first lead tab so as to form a first welding portion located in the first recess of the negative electrode current collector, and
wherein the second tab portion of the positive electrode is welded to the second lead tab so as to form a second welding portion located in the second recess of the positive electrode current collector.

2. The battery of claim 1, wherein
the first lead tab comprises:
a 1-1 portion extending outward from the plurality of negative electrodes; and
a 1-2 portion coupled to the first recess, wherein the first welding portion is formed on the 1-2 portion, and
wherein the second lead tab comprises:
a 2-1 portion extending outward from the plurality of positive electrodes; and
a 2-2 portion coupled to the second recess, wherein the second welding portion is formed on the 2-2 portion.

3. The battery of claim 2, wherein the 1-1 portion extends in an outward direction of the first recess from the 1-2 portion, and
wherein the 2-1 portion extends in an outward direction of the second recess from the 2-2 portion.

4. The battery of claim 1, further comprising an electrode assembly formed by stacking the plurality of negative electrodes and the plurality of positive electrodes,
wherein the first welding portion and the second welding portion are inside the electrode assembly.

5. The battery of claim 1, wherein at least a portion of the separator is between the negative electrode current collector and the positive electrode current collector.

6. The battery of claim 1, wherein at least a portion of the separator is between the first welding portion and the second welding portion.

7. The battery of claim 1, wherein the first recess is formed in a first body of the negative electrode current collector, the first body comprising a first active material, and
wherein the second recess is formed in a second body of the positive electrode current collector, the second body comprising a second active material.

8. The battery of claim 1, wherein the first tab portion and the second tab portion are bent on an edge of the separator.

9. The battery of claim 1, wherein the separator comprises:
a separator end region on which at least a portion of the first tab portion or the second tab portion is latched.

10. The battery of claim 1, further comprising a battery cell comprising the plurality of negative electrodes, the plurality of positive electrodes, the separator, the first lead tab, and the second lead tab.

11. A method for manufacturing a battery including an electrode assembly and at least one lead tab at least partially extending outward from the electrode assembly, the method comprising:
performing a first process of manufacturing an electrode plate pile including a plurality of first electrode plates and a plurality of second electrode plates arranged alternately with the plurality of the first electrode plates;
performing a second process of placing a first base electrode plate, to which a first lead tab is coupled, on one side of the electrode plate pile and welding the first lead tab to first tab portions of each of the plurality of first electrode plates; and
performing a third process of placing a second base electrode plate, to which a second lead tab is coupled, on the one side of the electrode plate pile and welding the second lead tab to second tab portions of each of the plurality of second electrode plates.

12. The method of claim 11, wherein the first lead tab includes a first welding portion to which the first tab portions are welded, and the second lead tab includes a second welding portion to which the second tab portions are welded.

13. The method of claim 11, further comprising performing a fourth process of placing a separator between the first base electrode plate and the second base electrode plate, and folding and stacking the separator on the first base electrode plate or the second base electrode plate.

14. The method of claim 13, further comprising performing a fifth process of stacking any one of the plurality of first electrode plates included in the electrode plate pile or any one of the plurality of second electrode plates included in the electrode plate pile on the separator.

15. The method of claim 14, further comprising repeating and alternately performing the fourth process and the fifth process.

16. An electronic device, comprising:
a housing;
a processor; and
a battery in the housing,
wherein the battery comprises:
an electrode assembly; and
at least one lead tab at least partially extending outward from the electrode assembly,
wherein the electrode assembly comprises:
a plurality of first electrode plates;
a plurality of second electrode plates arranged alternately with the plurality of first electrode plates; and
at least one separator between the plurality of first electrode plates and the plurality of second electrode plates, which are arranged alternately with each other, and
wherein each of the at least one lead tab comprises:
a first portion extending in an outward direction of the electrode assembly; and
a second portion extending from the first portion and having at least one surface, on which a welding portion is formed, facing the at least one separator.

17. The electronic device of claim 16, wherein the at least one lead tab comprises a first lead tab and a second lead tab,
wherein the welding portion of the first lead tab is a first welding portion welded to at least one of the plurality of first electrode plates, and
wherein the welding portion of the second lead tab is a second welding portion welded to at least one of the plurality of second electrode plates.

18. The electronic device of claim 16, wherein the at least one lead tab comprises a first lead tab and a second lead tab,
wherein the welding portion of the first lead tab is a first welding portion to which first tab portions of each of the plurality of first electrode plates are welded, and
wherein the welding portion of the second lead tab is a second welding portion to which second tab portions of each of the plurality of second electrode plates are welded.

19. The electronic device of claim 16, wherein the at least one lead tab comprises a first lead tab and a second lead tab.

20. The electronic device of claim 18, wherein the plurality of first electrode plates comprises a first base electrode plate where the first welding portion is formed, and
wherein the plurality of second electrode plates comprises a second base electrode plate where the second welding portion is formed.
